(19) United States
(12) Patent Application Publication
(10) Pub. No.: US 2021/0348003 A1
(43) Pub. Date: Nov. 11, 2021

(54) AQUEOUS BASECOAT AND PRODUCTION OF MULTI-COAT PAINT SYSTEMS USING THE BASECOAT

(71) Applicant: BASF Coatings GmbH, Münster (DE)

(72) Inventors: Wen Jing LI, Shanghai (CN); Dirk Eierhoff, Muenster (DE); Zenon Paul Czornij, Southfield, MI (US); Phyllis A Weaks, Southfield, MI (US); Klaus-Juergen Kanngiesser, Muenster (DE); Meng Xing LI, Shanghai (CN)

(21) Appl. No.: 17/042,259

(22) PCT Filed: Mar. 5, 2019
(86) PCT No.: PCT/EP2019/055435

§ 371 Date: Nov. 30, 2020

(30) Foreign Application Priority Data
Mar. 28, 2018 (EP) 18164501.1

(51) Int. Cl. C09D 5/36; C09D 5/02; C09D 5/00; C09D 7/65; C09D 133/06; B05D 1/04; B05D 7/14; B05D 7/00

(52) U.S. Cl. CPC C09D 5/36; C09D 5/022; C09D 5/002; C09D 7/65; B05D 7/572; B05D 1/04; B05D 7/14; B05D 7/532; C09D 133/066

(57) ABSTRACT

The present disclosure relates to an aqueous basecoat material including as binder, at least one aqueous, acrylate-based microgel dispersion (MD), and also at least one pigment paste including at least one color and/or effect pigment, and also as paste binder, at least one polymer of olefinically unsaturated monomers, where the polymer includes functional groups for nonionic stabilization of the polymer in water, and also functional groups selected from the group of silicon-containing, phosphorus-containing, and urea-containing groups, the aqueous basecoat material further including less than 0.5 wt %, based on its total weight, of synthetic phyllosilicates.

### CROSS-REFERENCE TO RELATED APPLICATIONS

This application is a U.S. National Phase Application of PCT/EP2019/055435, filed on Mar. 5, 2019, which claims the benefit of priority to European Patent Application Number 18164501.1, filed Mar. 28, 2018, the entire contents of which are hereby incorporated by reference herein.

The present invention relates to an aqueous basecoat material (also called waterborne basecoat). The present invention also relates to a method for producing a multicoat paint system which entails producing at least one basecoat film using at least one such aqueous basecoat material. The present invention relates, moreover, to a multicoat paint system produced by the method of the invention.

### PRIOR ART

Multicoat paint systems on metallic substrates or plastics substrates, examples being multicoat paint systems in the sector of the automobile industry, are known. On metallic substrates, such multicoat paint systems comprise generally, viewed from the metallic substrate outward, a separately cured electrocoat film, a layer applied directly to the electrocoat film and cured separately, usually referred to as primer-surfacer coat, at least one film comprising color and/or effect pigments and referred to in general as basecoat, and also a clearcoat. Basecoat film and clearcoat film are generally cured jointly.

Plastics substrates, which are relevant in the sector of components for installation in or on vehicles, generally likewise have corresponding basecoats and clearcoats applied to them. In some cases certain primer-surfacers or adhesion primers are also applied before the application of the basecoat.

In connection with metal substrates in particular there are approaches which avoid the separate curing step of the coating material applied directly to the cured electrocoat film (i.e., of the coating material referred to as primer-surfacer in the standard procedure described above). Within the world of the art, therefore, this coating film which is not separately cured is then frequently referred to as basecoat film (and no longer as primer-surfacer film) and/or as first basecoat film, in delimitation from a second basecoat film applied thereon. In some cases, indeed, this coating film is done away with entirely (in which case, then, only a so-called basecoat film is produced directly on the electrocoat film, and is overcoated with a clearcoat material without a separate curing step, meaning that ultimately again a separate curing step is omitted). In place of the separate curing step and in place of an additional concluded curing step, therefore, the intention is that only a concluded curing step take place following application of all coating films applied on the electrocoat film.

Doing away with a separate curing step for the coating material applied directly to the electrocoat film is very advantageous from standpoints of economics and environment. This is because it leads to energy saving, and the overall production operation can of course proceed with substantially more stringency.

Similar methods are known in connection with plastics processes, though in that case of course no electrocoat film is produced. The system for joint curing, made up of first basecoat material, second basecoat material, and clearcoat material, is therefore applied, for example, directly to the plastic substrate, which has optionally been given a surface-activating primer layer which has first been applied to the substrate.

Although the technological properties of existing multicoat paint systems are already often enough to meet the specifications of the automakers, there continues to be a requirement to improve them. This is so in particular in connection with the latterly described multicoat paint system production method in which, as stated, a separate curing step is omitted. The standard methods additionally described above for producing multicoat paint systems are also amenable to optimization in this regard as well, however.

A particular challenge is to provide multicoat paint systems wherein very good optical properties, such as avoidance of pops or pinholes, for example, and also a good overall visual impression (appearance) and hence effective leveling of the coating materials constituting the system, are achieved. In the case of metallic effect paints, a further factor is that the achievement of a good flop effect is highly relevant. It is important, moreover, that the coating materials making up the system, particularly the pigmented waterborne paints, exhibit high storage stability.

In order to obtain the above-stated advantages in respect of storage stability, leveling, and flop effect in the case of waterborne basecoat materials, it is common to employ well-known and fundamentally established rheological assistants that are based on inorganic, often synthetic, phyllosilicates.

Although these assistants are in many cases highly advantageous, there is an improvement potential to be made out here as well.

Hence it is known from EP 2245097B1 that the use of synthetic phyllosilicates, while affording many advantages, can nevertheless lead to pinholes. Moreover, in connection with corresponding metallic paints, it is known that an application based purely on electrostatic atomization is fundamentally inadequate for obtaining a good flop effect in basecoat films (that is, ultimately, a good and uniform orientation of the metallic effect pigments) (WO 2012015717, WO 2012015718). A twofold application is instead required here to achieve an optimum outcome, with one step taking place in the form of pneumatic application. Pneumatic application, however, is disadvantageous because of the great inefficiency resulting from the massively high atomization loss and hence loss of material.

Other disadvantages around the use of synthetic phyllosilicates lie in the distinct reduction in formulation freedom resulting from their use. The phyllosilicates must in general be used in aqueous suspensions of very low concentration, in order to ensure proportionate transfer into the coating formulation. At the same time this also means that negative effects on the volume solids content of the formulation can also be expected.

Simply omitting the synthetic phyllosilicates, however, is generally not an option, since it entails extremely poor rheological properties. The storage stability is poor, and the leveling or sag resistance of the newly applied coating material on the substrate is also unacceptable.

In the publications described above, the problem is tackled by a combination of organic rheological assistants that requires specific adaptation, in conjunction with omission of the synthetic phyllosilicates.

There would be utility in an approach which, rather than involving the use of specific additives, which make the coating formulations significantly more complex, instead manages with constituents which are typically present anyway in the coating formulations and/or which can be used advantageously, more particularly resins as binders, in order to achieve the advantages described above.

WO 2016116299 A1 discloses an emulsion polymer of olefinically unsaturated monomers that is prepared in three stages, and the use thereof as binder in basecoat materials.

U.S. Pat. Nos. 5,270,399 and 5,320,673 disclose polymers containing functional organic groups and stabilized nonionically in water, these groups comprising silicon-containing, phosphorus-containing or urea-containing groups, and the use of said polymers as paste resins in pigment pastes.

### Problem and Solution

The present invention, accordingly, addressed the problem of providing an aqueous basecoat material which in spite of the complete or near-complete omission of synthetic phyllosilicates can be formulated and at the same time exhibits the above advantages in terms of flop effect and pinholing behavior, but also, in particular, in respect of storage stability and leveling. At the same time the coating material ought to be able to be formulated via binder constituents which are already present anyway or can be used advantageously.

As a solution to these problems, an aqueous basecoat material has been found, comprising
(I) as binder, at least one aqueous, acrylate-based microgel dispersion (MD), and also
(II) at least one pigment paste comprising
   (IIa) at least one color and/or effect pigment, and also
   (IIb) as paste binder, at least one polymer of olefinically unsaturated monomers, where the polymer comprises
      (IIb.1) functional groups for nonionic stabilization of the polymer in water, and also
      (IIb.2) functional groups selected from the group of silicon-containing, phosphorus-containing, and urea-containing groups,
         the basecoat material further comprising less than 0.5 wt %, based on its total weight, of synthetic phyllosilicates.

The aqueous basecoat material identified above is also referred to below as basecoat material of the invention and accordingly is a subject of the present invention. Preferred embodiments of the basecoat material of the invention are apparent from the dependent claims and also from the description hereinafter.

A further subject of the present invention is a method for producing a multicoat paint system wherein at least one basecoat film is produced using at least one aqueous basecoat material of the invention. The present invention relates, furthermore, to a multicoat paint system produced according to the method of the invention.

### DETAILED DESCRIPTION

The basecoat material of the invention comprises (I) at least one, preferably precisely one, aqueous, acrylate-based microgel dispersion (MD).

Microgel dispersions, also called latex in the prior art, are fundamentally known. They are a polymer dispersion in which on the one hand the polymer is present in the form of comparatively small particles having particle sizes of, for example, 0.02 to 10 micrometers (“micro”-gel). On the other hand, however, the polymer particles are at least partially intramolecularly crosslinked, with the internal structure therefore equating to that of a typical polymeric three-dimensional network. Viewed macroscopically, a microgel dispersion of this kind is still a dispersion of polymer particles in a dispersion medium, water for example. While the particles may also in part have crosslinking bridges with one another (which can hardly be ruled out in light not least of the production process), the system is nevertheless at any rate a dispersion containing discrete particles which have a measurable average particle size.

The fraction of the crosslinked polymers can be determined following isolation of the solid polymer by removal of water and optionally organic solvents and subsequent extraction. The crosslinking can be verified via the gel fraction, which is accessible experimentally. Ultimately the gel fraction constitutes that fraction of the polymer from the dispersion that, as an isolated solid, cannot be dissolved molecularly dispersely in a solvent. In this context it is necessary to rule out subsequent crosslinking reactions further increasing the gel fraction when the polymeric solid is isolated. This insoluble fraction corresponds in turn to the fraction of the polymer present in the dispersion in the form of intramolecularly crosslinked particles or particle fractions.

The microgels for use in the context of the present invention are acrylate-based. They comprise or consist of corresponding copolymerized acrylate-based monomers. Besides the characterizing acrylate monomers, such microgels may of course also comprise further monomers, which may likewise be incorporated into the polymer by radical copolymerization.

The polymer particles present in the microgel dispersion preferably have an average particle size of 100 to 500 nm (for measurement method see below).

Fundamental methods of producing such microgels are known and are described in the prior art. Moreover, an exemplary exposition is given in connection with the preferred embodiments described below. The dispersions (MD) for use in accordance with the invention are produced preferably by way of radical emulsion polymerization.

The preparation of the polymer preferably comprises the successive radical emulsion polymerization of three different mixtures (A), (B), and (C), of olefinically unsaturated monomers. It is therefore a multistage radical emulsion polymerization where i. first the mixture (A) is polymerized, then ii. the mixture (B) is polymerized in the presence of the polymer prepared under i., and, furthermore, iii. the mixture (C) is polymerized in the presence of the polymer prepared under ii. All three monomer mixtures are therefore polymerized via a separately conducted radical emulsion polymerization (i.e., stage or else polymerization stage), with these stages taking place in succession.

Viewed in terms of time, the stages may take place directly one after another. It is equally possible, after the end of one stage, for the corresponding reaction solution to be stored for a certain time period and/or to be transferred to a different reaction vessel, with the next stage taking place only then. With preference the preparation of the specific multistage polymer comprises no polymerization steps other than the polymerization of the monomer mixtures (A), (B), and (C).

The concept of radical emulsion polymerization is known to the skilled person and is elucidated in more detail again below, moreover.

In such a polymerization, olefinically unsaturated monomers are polymerized in an aqueous medium with use of at least one water-soluble initiator and in the presence of at least one emulsifier.

Corresponding water-soluble initiators are likewise known. The at least one water-soluble initiator is preferably selected from the group consisting of potassium, sodium or ammonium peroxodisulfate, hydrogen peroxide, tert-butyl hydroperoxide, 2,2′-azobis(2-amidoisopropane) dihydrochloride, 2,2′-azobis(N,N′-dimethyleneisobutyramidine) dihydrochloride, 2,2′-azobis(4-cyanopentanoic acid), and also mixtures of the aforesaid initiators, such as of hydrogen peroxide and sodium persulfate for example. Also members of the stated preferred group are the redox initiator systems which are known per se.

By redox initiator systems are meant, in particular, those initiators which comprise at least one peroxide-containing compound in combination with at least one redox coinitiator, examples being reductive sulfur compounds such as, for example, bisulfites, sulfites, thiosulfates, dithionites or tetrathionates of alkali metals and ammonium compounds, sodium hydroxymethanesulfinate dihydrate and/or thiourea. Hence it is possible to employ combinations of peroxodisulfates with alkali metal or ammonium hydrogensulfites, as for example ammonium peroxodisulfate and ammonium disulfite. The weight ratio of peroxide-containing compounds to the redox coinitiators is preferably 50:1 to 0.05:1.

In combination with the initiators, transition metal catalysts may additionally be used, such as, for example, salts of iron, of nickel, of cobalt, of manganese, of copper, of vanadium or of chromium, such as iron(II) sulfate, cobalt(II) chloride, nickel(II) sulfate, copper(I) chloride, manganese(II) acetate, vanadium(III) acetate, manganese(II) chloride. Based on the total mass of the olefinically unsaturated monomers used in a polymerization, these transition metal salts are employed customarily in amounts of 0.1 to 1000 ppm. Hence it is possible to employ combinations of hydrogen peroxide with iron(II) salts, such as, for example, 0.5 to 30 wt % of hydrogen peroxide and 0.1 to 500 ppm of Mohr's salt, with the fractional ranges being based in each case on the total weight of the monomers used in the particular polymerization stage.

The initiators are used preferably in an amount of 0.05 to 20 wt %, preferably 0.05 to 10, more preferably of 0.1 to 5 wt %, based on the total weight of the monomers used in the respective polymerization stage.

An emulsion polymerization proceeds in a reaction medium that comprises water as continuous medium and the at least one emulsifier in the form of micelles. The polymerization is started by decomposition of the water-soluble initiator in the water. The growing polymer chain is incorporated into the emulsifier micelles and the further polymerization then takes place within the micelles. As well as the monomers, the at least one water-soluble initiator, and the at least one emulsifier, therefore, the reaction mixture consists primarily of water. The stated components, namely monomers, water-soluble initiator, emulsifier, and water, account preferably for at least 95 wt % of the reaction mixture. With preference the reaction mixture consists of these components.

It is therefore evidently possible for at least one emulsifier to be added in each individual polymerization stage. Equally possible, however, is the addition of at least one emulsifier only in one (in the first) or in two polymerization stage(s) (in the first stage and in a further stage). The amount of emulsifier is in that case selected such that a sufficient amount of emulsifier is present even for the stages in which there is no separate addition.

Emulsifiers as well are known fundamentally. Those used may be nonionic or ionic emulsifiers, including zwitterionic emulsifiers, and also, optionally, mixtures of the aforesaid emulsifiers.

Preferred emulsifiers are optionally ethoxylated and/or propoxylated alkanols having 10 to 40 carbon atoms. They can have different degrees of ethoxylation and/or propoxylation (for example, adducts modified with poly(oxy)ethylene and/or poly(oxy)propylene chains consisting of 5 to 50 molecular units). Sulfated, sulfonated or phosphated derivatives of the aforesaid products may also be employed. Such derivatives are generally used in neutralized form.

Particularly preferred emulsifiers suitable are neutralized dialkylsulfosuccinic esters or alkyldiphenyl oxide disulfonates, available commercially in the form of EF-800 from Cytec, for example.

The emulsion polymerizations are carried out usefully at a temperature of 0 to 160° C., preferably of 15 to 95° C., more preferably 60 to 95° C. This operation takes place preferably in the absence of oxygen, with preference under an inert gas atmosphere. In general the polymerization is conducted under atmospheric pressure, although the use of lower pressures or higher pressures is also possible. Particularly if polymerization temperatures are employed which lie above the boiling point, under standard pressure, of water, of the monomers used and/or of the organic solvents, then generally higher pressures are selected.

The individual polymerization stages in the preparation of the specific polymer may be carried out, for example, as what are called “starved feed” polymerizations (also known as “starve feed” or “starve fed” polymerizations).

A starved feed polymerization in the sense of the present invention is an emulsion polymerization in which the amount of free olefinically unsaturated monomers in the reaction solution (also called reaction mixture) is minimized throughout the reaction time. This means that the metered addition of the olefinically unsaturated monomers is such that over the entire reaction time a fraction of free monomers in the reaction solution does not exceed 6.0 wt %, preferably 5.0 wt %, more preferably 4.0 wt %, particularly advantageously 3.5 wt %, based in each case on the total amount of the monomers used in the respective polymerization stage. Further preferred within these strictures are concentration ranges for the olefinically unsaturated monomers of 0.01 to 6.0 wt %, preferably 0.02 to 5.0 wt %, more preferably 0.03 to 4.0 wt %, more particularly 0.05 to 3.5 wt %. For example, the highest weight fraction detectable during the reaction may be 0.5 wt %, 1.0 wt %, 1.5 wt %, 2.0 wt %, 2.5 wt %, or 3.0 wt %, while all other values detected then lie below the values indicated here. The total amount (also called total weight) of the monomers used in the respective polymerization stage evidently corresponds for stage i. to the total amount of the monomer mixture (A), for stage ii. to the total amount of the monomer mixture (B), and for stage iii. to the total amount of the monomer mixture (C).

The concentration of the monomers in the reaction solution here may be determined by gas chromatography, for example. In that case a sample of the reaction solution is cooled with liquid nitrogen immediately after sampling, and 4-methoxyphenol is added as an inhibitor. In the next step, the sample is dissolved in tetrahydrofuran and then n-pentane is added in order to precipitate the polymer formed at the time of sampling. The liquid phase (supernatant) is then analyzed by gas chromatography, using a polar column and an apolar column for determining the monomers, and a flame ionization detector. Typical parameters for the gas-chromatographic determination are as follows: 25 m silica capillary column with 5% phenyl-, 1% vinyl-methylpolysiloxane phase, or 30 m silica capillary column with 50% phenyl-, 50% methyl-polysiloxane phase, carrier gas hydrogen, split injector 150° C., oven temperature 50 to 180° C., flame ionization detector, detector temperature 275° C., internal standard isobutyl acrylate. The concentration of the monomers is determined, for the purposes of the present invention, preferably by gas chromatography, more particularly in compliance with the parameters specified above.

The fraction of the free monomers can be controlled in various ways.

One possibility for keeping the fraction of the free monomers low is to select a very low metering rate for the mixture of the olefinically unsaturated monomers into the actual reaction solution, wherein the monomers make contact with the initiator. If the metering rate is so low that all of the monomers are able to react virtually immediately when they are in the reaction solution, it is possible to ensure that the fraction of the free monomers is minimized.

In addition to the metering rate it is important that there are always sufficient radicals present in the reaction solution to allow each of the added monomers to react extremely quickly. In this way, further chain growth of the polymer is guaranteed and the fraction of free monomer is kept low.

For this purpose, the reaction conditions are preferably selected such that the initiator feed is commenced even before the start of the metering of the olefinically unsaturated monomers. The metering is preferably commenced at least 5 minutes beforehand, more preferably at least 10 minutes beforehand. With preference at least 10 wt % of the initiator, more preferably at least 20 wt %, very preferably at least 30 wt % of the initiator, based in each case on the total amount of initiator, is added before the metering of the olefinically unsaturated monomers is commenced.

Preference is given to selecting a temperature which allows constant decomposition of the initiator.

The amount of initiator is likewise an important factor for the sufficient presence of radicals in the reaction solution. The amount of initiator should be selected such that at any given time there are sufficient radicals available, allowing the added monomers to react. If the amount of initiator is increased, it is also possible to react greater amounts of monomers at the same time.

A further factor determining the reaction rate is the reactivity of the monomers.

Control over the fraction of the free monomers can therefore be guided by the interplay of initiator quantity, rate of initiator addition, rate of monomer addition, and through the selection of the monomers. Not only a slowing-down of metering but also an increase in the initial quantity, and also the premature commencement of addition of the initiator, serve the aim of keeping the concentration of free monomers below the limits stated above.

At any point during the reaction, the concentration of the free monomers can be determined by gas chromatography, as described above.

Should this analysis find a concentration of free monomers that comes close to the limiting value for the starved feed polymerization, as a result, for example, of small fractions of highly reactive olefinically unsaturated monomers, the parameters referred to above can be utilized in order to control the reaction. In this case, for example, the metering rate of the monomers can be reduced, or the amount of initiator can be increased.

For the purposes of the present invention it is preferable for the polymerization stages ii. and iii. to be carried out under starved feed conditions. This has the advantage that the formation of new particle nuclei within these two polymerization stages is effectively minimized. Instead, the particles existing after stage i. (and therefore also called seed below) can be grown further in stage ii. by the polymerization of the monomer mixture B (therefore also called core below). It is likewise possible for the particles existing after stage ii. (also below called polymer comprising seed and core) to be grown further in stage iii. through the polymerization of the monomer mixture C (therefore also called shell below), resulting ultimately in a polymer comprising particles containing seed, core, and shell.

The mixtures (A), (B), and (C) are mixtures of olefinically unsaturated monomers. Suitable olefinically unsaturated monomers may be mono- or polyolefinically unsaturated.

Described first of all below are monomers which can be used in principle and which are suitable across all mixtures (A), (B), and (C), and monomers that are optionally preferred. Specific preferred embodiments of the individual mixtures are addressed thereafter.

Examples of suitable monoolefinically unsaturated monomers include, in particular, (meth)acrylate-based monoolefinically unsaturated monomers, monoolefinically unsaturated monomers containing allyl groups, and other monoolefinically unsaturated monomers containing vinyl groups, such as vinylaromatic monomers, for example. The term (meth)acrylic or (meth)acrylate for the purposes of the present invention encompasses both methacrylates and acrylates. Preferred for use at any rate, although not necessarily exclusively, are (meth)acrylate-based monoolefinically unsaturated monomers.

The (meth)acrylate-based monoolefinically unsaturated monomers may be, for example, (meth)acrylic acid and esters, nitriles, or amides of (meth)acrylic acid.

Preference is given to esters of (meth)acrylic acid having a non-olefinically unsaturated radical R.

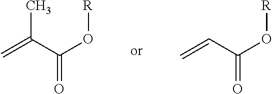

The radical R may be saturated aliphatic, aromatic, or mixed saturated aliphatic-aromatic. Aliphatic radicals for the purposes of the present invention are all organic radicals which are not aromatic. Preferably the radical R is aliphatic.

The saturated aliphatic radical may be a pure hydrocarbon radical or it may include heteroatoms from bridging groups (for example, oxygen from ether groups or ester groups) and/or may be substituted by functional groups containing heteroatoms (alcohol groups, for example). For the purposes of the present invention, therefore, a clear distinction is made between bridging groups containing heteroatoms and functional groups containing heteroatoms (that is, terminal functional groups containing heteroatoms).

Preference is given at any rate, though not necessarily exclusively, to using monomers in which the saturated aliphatic radical R is a pure hydrocarbon radical (alkyl radical), in other words one which does not include any heteroatoms from bridging groups (oxygen from ether groups, for example) and is also not substituted by functional groups (alcohol groups, for example).

If R is an alkyl radical, it may for example be a linear, branched, or cyclic alkyl radical. Such an alkyl radical may of course also have linear and cyclic or branched and cyclic structural components. The alkyl radical preferably has 1 to 20, more preferably 1 to 10, carbon atoms.

Particularly preferred monounsaturated esters of (meth)acrylic acid with an alkyl radical are methyl (meth)acrylate, ethyl (meth)acrylate, propyl (meth)-acrylate, isopropyl (meth)acrylate, n-butyl (meth)-acrylate, isobutyl (meth)acrylate, tert-butyl (meth)-acrylate, amyl (meth)acrylate, hexyl (meth)acrylate, ethylhexyl (meth)acrylate, 3,3,5-trimethylhexyl (meth)-acrylate, stearyl (meth)acrylate, lauryl (meth)-acrylate, cycloalkyl (meth)acrylates, such as cyclo-pentyl (meth)acrylate, isobornyl (meth)acrylate, and also cyclohexyl (meth)acrylate, with very particular preference being given to n- and tert-butyl (meth)-acrylate and to methyl methacrylate.

Examples of other suitable radicals R are saturated aliphatic radicals which comprise functional groups containing heteroatoms (for example, alcohol groups or phosphoric ester groups).

Suitable monounsaturated esters of (meth)acrylic acid with a saturated aliphatic radical substituted by one or more hydroxyl groups are 2-hydroxyethyl (meth)-acrylate, 2-hydroxypropyl (meth) acrylate, 3-hydroxypropyl (meth)acrylate, 3-hydroxybutyl (meth)acrylate, and 4-hydroxybutyl (meth)acrylate, with very particular preference being given to 2-hydroxyethyl (meth)-acrylate.

Suitable monounsaturated esters of (meth)acrylic acid with phosphoric ester groups are, for example, phosphoric esters of polypropylene glycol monometh-acrylate, such as the commercially available Sipomer PAM 200 from Rhodia.

Possible further monoolefinically unsaturated monomers containing vinyl groups are monomers which are different from the above-described acrylate-based monomers and which have a radical R′ on the vinyl group that is not olefinically unsaturated.

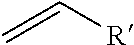

The radical R′ may be saturated aliphatic, aromatic, or mixed saturated aliphatic-aromatic, with preference being given to aromatic and mixed saturated aliphatic-aromatic radicals in which the aliphatic components represent alkyl groups.

Particularly preferred further monoolefinically unsaturated monomers containing vinyl groups are, in particular, vinyltoluene, alpha-methylstyrene, and especially styrene.

Also possible are monounsaturated monomers containing vinyl groups wherein the radical R′ has the following structure:

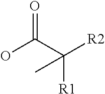

where the radicals R1 and R2 as alkyl radicals contain a total of 7 carbon atoms. Monomers of this kind are available commercially under the name VeoVa 10 from Momentive.

Further monomers suitable in principle are olefinically unsaturated monomers such as acrylonitrile, methacrylo-nitrile, acrylamide, methacrylamide, N,N-dimethylacryl-amide, vinyl acetate, vinyl propionate, vinyl chloride, N-vinylpyrrolidone, N-vinylcaprolactam, N-vinylform-amide, N-vinylimidazole, N-vinyl-2-methylimidazoline, and further unsaturated alpha-beta-carboxylic acids.

Examples of suitable polyolefinically unsaturated monomers include esters of (meth)acrylic acid with an olefinically unsaturated radical R″. The radical R″ may be, for example, an allyl radical or a (meth)acryloyl radical.

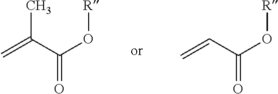

Preferred polyolefinically unsaturated monomers include ethylene glycol di(meth)acrylate, 1,2-propylene glycol di(meth)acrylate, 2,2-propylene glycol di(meth)-acrylate, butane-1,4-diol di(meth)acrylate, neopentyl glycol di(meth)acrylate, 3-methylpentanediol di(meth)-acrylate, diethylene glycol di(meth)acrylate, triethylene glycol di(meth)acrylate, tetraethylene glycol di(meth)acrylate, dipropylene glycol di(meth)-acrylate, tripropylene glycol di(meth)acrylate, hexanediol di(meth)acrylate, and allyl (meth)acrylate.

Furthermore, preferred polyolefinically unsaturated compounds encompass acrylic and methacrylic esters of alcohols having more than two OH groups, such as, for example, trimethylolpropane tri(meth)acrylate or glycerol tri(meth)acrylate, but also trimethylolpropane di(meth)acrylate monoallyl ether, trimethylolpropane (meth)acrylate diallyl ether, pentaerythritol tri(meth)acrylate monoallyl ether, pentaerythritol di(meth)acrylate diallyl ether, pentaerythritol (meth)-acrylate triallyl ether, triallylsucrose, and penta-allylsucrose.

Also possible are allyl ethers of mono- or polyhydric alcohols, such as trimethylolpropane monoallyl ether, for example.

Where used, which is preferred, preferred polyolefinically unsaturated monomers are hexanediol diacrylate and/or allyl (meth)acrylate.

With regard to the monomer mixtures (A), (B), and (C) used in the individual polymerization stages, there are specific conditions to be observed, which are set out below.

First of all it should be stated that the mixtures (A), (B), and (C) are at any rate different from one another. They therefore each contain different monomers and/or different proportions of at least one defined monomer.

Mixture (A) comprises, preferably but not necessarily, at least 50 wt %, more preferably at least 55 wt %, of olefinically unsaturated monomers having a water solubility of less than 0.5 g/l at 25° C. One such preferred monomer is styrene.

The solubility of the monomers in water can be determined via establishment of equilibrium with the gas space above the aqueous phase (in analogy to the reference X.-S. Chai, Q. X. Hou, F. J. Schork, Journal of Applied Polymer Science Vol. 99, 1296-1301 (2006)).

For this purpose, in a 20 ml gas space sample tube, to a defined volume of water, preferably 2 ml, a mass of the respective monomer is added which is of a magnitude such that this mass can at any rate not be dissolved completely in the selected volume of water.

Additionally an emulsifier is added (10 ppm, based on total mass of the sample mixture). In order to obtain the equilibrium concentration, the mixture is shaken continually. The supernatant gas phase is replaced by inert gas, and so an equilibrium is established again. In the gas phase withdrawn, the fraction of the substance to be detected is measured (preferably by gas chromatography). The equilibrium concentration in water can be determined by plotting the fraction of the monomer in the gas phase. The slope of the curve changes from a virtually constant value (S1) to a significantly negative slope (S2) as soon as the excess monomer fraction has been removed from the mixture. The equilibrium concentration here is reached at the point of intersection of the straight line with the slope S1 and of the straight line with the slope S2. The determination described is carried out at 25° C.

The monomer mixture (A) preferably contains no hydroxy-functional monomers. Likewise preferably, the monomer mixture (A) contains no acid-functional monomers.

Very preferably the monomer mixture (A) contains no monomers at all that have functional groups containing heteroatoms. This means that heteroatoms, if present, are present only in the form of bridging groups. This is the case, for example, in the monoolefinically unsaturated monomers described above that are (meth)acrylate-based and possess an alkyl radical as radical R.

The monomer mixture (A) preferably comprises exclusively monoolefinically unsaturated monomers.

In one particularly preferred embodiment, the monomer mixture (A) comprises at least one monounsaturated ester of (meth)acrylic acid with an alkyl radical and at least one monoolefinically unsaturated monomer containing vinyl groups, with a radical arranged on the vinyl group that is aromatic or that is mixed saturated aliphatic-aromatic, in which case the aliphatic fractions of the radical are alkyl groups.

The monomers present in the mixture (A) are selected such that a polymer prepared from them possesses a glass transition temperature of 10 to 65° C., preferably of 30 to 50° C.

The glass transition temperature T_{g} for the purposes of the invention is determined experimentally on the basis of DIN 51005 “Thermal Analysis (TA)—terms” and DIN 53765 “Thermal Analysis—Dynamic Scanning calorimetry (DSC)”. This involves weighing out a 15 mg sample into a sample boat and introducing it into a DSC instrument. After cooling to the start temperature, 1st and 2nd measurement runs are carried out with inert gas flushing (N₂) of 50 ml/min with a heating rate of 10 K/min, with cooling to the start temperature again between the measurement runs. Measurement takes place customarily in the temperature range from about 50° C. lower than the expected glass transition temperature to about 50° C. higher than the glass transition temperature. The glass transition temperature for the purposes of the present invention, in accordance with DIN 53765, section 8.1, is that temperature in the 2nd measurement run at which half of the change in the specific heat capacity (0.5 delta cₚ) is reached. This temperature is determined from the DSC diagram (plot of the heat flow against the temperature). It is the temperature at the point of intersection of the midline between the extrapolated baselines, before and after the glass transition, with the measurement plot.

Where reference is made in the context of the present invention to an official standard without any indication of the official validity period, the reference is of course to that version of the standard that is valid on the filing date or, if there is no valid version at that point in time, to the last valid version.

For a useful estimation of the glass transition temperature to be expected in the measurement, the known Fox equation can be employed. Since the Fox equation represents a good approximation, based on the glass transition temperatures of the homopolymers and their parts by weight, without incorporation of the molecular weight, it can be used as a guide to the skilled person in the synthesis, allowing a desired glass transition temperature to be set via a few goal-directed experiments.

The polymer prepared in stage i. by the emulsion polymerization of the monomer mixture (A) is also called seed.

The seed possesses preferably an average particle size of 20 to 125 nm (for measurement method see Examples section).

Mixture (B) preferably comprises at least one polyolefinically unsaturated monomer, more preferably at least one diolefinically unsaturated monomer. One such preferred monomer is hexanediol diacrylate.

The monomer mixture (B) preferably contains no hydroxy-functional monomers. Likewise preferably, the monomer mixture (B) contains no acid-functional monomers.

Very preferably the monomer mixture (B) contains no monomers at all with functional groups containing heteroatoms. This means that heteroatoms, if present, are present only in the form of bridging groups. This is the case, for example, in the above-described monoolefinically unsaturated monomers which are (meth)acrylate-based and possess an alkyl radical as radical R.

In one particularly preferred embodiment, the monomer mixture (B), as well as the at least one polyolefinically unsaturated monomer, includes at any rate the following further monomers. First of all, at least one monounsaturated ester of (meth)acrylic acid with an alkyl radical, and secondly at least one monoolefinically unsaturated monomer containing vinyl groups and having a radical located on the vinyl group that is aromatic or that is a mixed saturated aliphatic-aromatic radical, in which case the aliphatic fractions of the radical are alkyl groups.

The fraction of polyunsaturated monomers is preferably from 0.05 to 3 mol %, based on the total molar amount of monomers in the monomer mixture (B).

The monomers present in the mixture (B) are selected such that a polymer prepared therefrom possesses a glass transition temperature of −35 to 15° C., preferably of −25 to +7° C.

The polymer prepared in the presence of the seed in stage ii. by the emulsion polymerization of the monomer mixture (B) is also referred to as the core. After stage ii., then, the result is a polymer which comprises seed and core.

The polymer which is obtained after stage ii. preferably possesses an average particle size of 80 to 280 nm, preferably 120 to 250 nm.

The monomers present in the mixture (C) are selected such that a polymer prepared therefrom possesses a glass transition temperature of −50 to 15° C., preferably of −20 to +12° C.

The olefinically unsaturated monomers of this mixture (C) are preferably selected such that the resulting polymer, comprising seed, core, and shell, has an acid number of 10 to 25.

Accordingly, the mixture (C) preferably comprises at least one alpha-beta unsaturated carboxylic acid, especially preferably (meth)acrylic acid.

The olefinically unsaturated monomers of the mixture (C) are further preferably selected such that the resulting polymer, comprising seed, core, and shell, has an OH number of 0 to 30, preferably 10 to 25.

All of the aforementioned acid numbers and OH numbers in connection with the dispersion (MD) are values calculated on the basis of the monomer mixtures employed overall.

In one particularly preferred embodiment, the monomer mixture (C) comprises at least one alpha-beta unsaturated carboxylic acid and at least one monounsaturated ester of (meth)acrylic acid having an alkyl radical substituted by a hydroxyl group.

In one especially preferred embodiment, the monomer mixture (C) comprises at least one alpha-beta unsaturated carboxylic acid, at least one monounsaturated ester of (meth)acrylic acid having an alkyl radical substituted by a hydroxyl group, and at least one monounsaturated ester of (meth)acrylic acid having an alkyl radical.

Where reference is made, in the context of the present invention, to an alkyl radical, without further particularization, what is always meant by this is a pure alkyl radical without functional groups and heteroatoms.

The polymer prepared in the presence of seed and core in stage iii. by the emulsion polymerization of the monomer mixture (C) is also referred to as the shell. The result after stage iii., then, is a polymer which comprises seed, core, and shell.

Following its preparation, the polymer of the microgel dispersion possesses an average particle size of preferably 100 to 500 nm, more preferably 125 to 400 nm, more preferably from 130 to 300 nm (independently of its method of preparation).

The aqueous dispersion (MD) preferably possesses a pH of 5.0 to 9.0, more preferably 7.0 to 8.5, very preferably 7.5 to 8.5. The pH may be kept constant during the preparation itself, through the use of bases as identified further on below, for example, or else may be set deliberately after the polymer has been prepared.

In especially preferred embodiments it is the case that the aqueous dispersion (MD) has a pH of 5.0 to 9.0 and the at least one polymer present therein has an average particle size of 100 to 500 nm. Even more preferred range combinations are as follows: pH of 7.0 to 8.5 and an average particle size of 125 to 400 nm, more preferably pH of 7.5 to 8.5 and a particle size of 130 to 300 nm.

Regarding the preferred embodiment of successive radical emulsion polymerizations of three different monomer mixtures (A), (B), and (C), it is further noted that the fractions of the monomer mixtures are preferably harmonized with one another as follows. The fraction of the mixture (A) is from 0.1 to 10 wt %, the fraction of the mixture (B) is from 60 to 80 wt %, and the fraction of the mixture (C) is from 10 to 30 wt %, based in each case on the sum of the individual amounts of the mixtures (A), (B), and (C).

The stages i. to iii. described are carried out preferably without addition of acids or bases known for the setting of the pH. If in the preparation of the polymer, for example, carboxy-functional monomers are then used, as is preferred in the context of stage iii., the pH of the dispersion may be less than 7 after the end of stage iii. Accordingly, an addition of base is needed in order to adjust the pH to a higher value, such as, for example, a value within the preferred ranges.

It follows from the above that the pH preferably after stage iii. is correspondingly adjusted or has to be adjusted, in particular through addition of a base such as an organic, nitrogen-containing base, such as an amine such as ammonia, trimethylamine, triethylamine, tributylamines, dimethylaniline, triphenylamine, N,N-dimethylethanolamine, methyldiethanolamine, or triethanolamine, and also by addition of sodium hydrogencarbonate or borates, and also mixtures of the aforesaid substances. This, however, does not rule out the possibility of adjusting the pH before, during, or after the emulsion polymerizations or else between the individual emulsion polymerizations. It is likewise possible for there to be no need at all for the pH to be adjusted to a desired value, owing to the choice of the monomers.

The measurement of the pH here is carried out preferably using a pH meter (for example, Mettler-Toledo S20 SevenEasy pH meter) having a combined pH electrode (for example, Mettler-Toledo InLab® Routine).

The solids content of the dispersion (MD) is preferably from 15% to 40% and more preferably 20% to 30%.

The dispersion (MD) is aqueous. The expression “aqueous” is known in this context to the skilled person. It refers fundamentally to a system which as its dispersion medium does not exclusively or primarily contain organic solvents (also called solvents), but where on the contrary the dispersion medium comprises a significant fraction of water. Preferred embodiments of the aqueous character, defined on the basis of the maximum amount of organic solvents and/or on the basis of the amount of water, may be specified, but do not cast doubt on the clarity of the expression “aqueous”.

It is preferably the case for the aqueous dispersion (MD) that it comprises a fraction of 55 to 75 wt %, especially preferably 60 to 70 wt %, based in each case on the total weight of the dispersion, of water.

It is further preferred for the percentage sum of the solids content of the dispersion (MD) and the fraction of water in the dispersion (MD) to be at least 80 wt %, preferably at least 90 wt %. Preferred in turn are ranges from 80 to 99 wt %, especially 90 to 97.5 wt %. In this figure, the solids content, which traditionally only possesses the unit “%”, is reported in “wt %”. Since the solids content ultimately also represents a percentage weight figure, this form of representation is justified. Where, for example, a dispersion has a solids content of 25% and a water content of 70 wt %, the above-defined percentage sum of the solids content and the fraction of water amounts to 95 wt %, therefore.

The dispersion accordingly consists very largely of water and of the specific polymer, and environmentally burdensome components, such as organic solvents in particular, are present only in minor proportions or not at all.

The aqueous microgel dispersion comprises by definition (see above) a fraction of crosslinked structures, in other words intramolecularly crosslinked regions of the polymer particles present. The dispersion preferably has a gel fraction of at least 50%, more preferably of at least 65%, especially preferably of at least 80%. The gel fraction may therefore amount to up to 100% or approximately 100%, such as 99% or 98%, for example. In such a case, then, the entire or virtually the entire polymer is present in the form of crosslinked particles.

The fraction of the one or more dispersions (MD), based on the total weight of the aqueous basecoat material of the invention, is preferably 1.0 to 60 wt %, more preferably 2.5 to 50 wt %, and very preferably 5 to 40 wt %.

The fraction of the polymers originating from the dispersions (MD), based on the total weight of the aqueous basecoat material of the invention, is preferably from 0.3 to 17.0 wt %, more preferably 0.7 to 14.0 wt %, very preferably 1.4 to 11.0 wt %.

The determination or specification of the fraction of the polymers in the basecoat material that originate from the dispersions (MD) for use in accordance with the invention may take place via the determination of the solids content (also called nonvolatile fraction, solids fraction or solids) of a dispersion (MD) which is to be used in the basecoat material. The same is of course true of any other components for use in the context of the present invention.

For the purposes of the present invention, the principle to be observed for the components for use in the basecoat material—for example, the components of a dispersion (MD)—is as follows (described here for a dispersion (MD)): In the case of a possible particularization to basecoat materials comprising preferred dispersions (MD) in a specific proportional range, the following applies. The dispersions (MD) which do not fall within the preferred group may of course still be present in the basecoat material. In that case the specific proportional range applies only to the preferred group of dispersions (MD). It is preferred nonetheless for the total proportion of dispersions (MD), consisting of dispersions from the preferred group and dispersions which are not part of the preferred group, to be subject likewise to the specific proportional range.

In the case of a restriction to a proportional range of 2.5 to 50 wt % and to a preferred group of dispersions (MD), therefore, this proportional range evidently applies initially only to the preferred group of dispersions (MD). In that case, however, it would be preferable for there to be likewise from 2.5 to 50 wt % in total present of all originally encompassed dispersions, consisting of dispersions from the preferred group and dispersions which do not form part of the preferred group. If, therefore, 35 wt % of dispersions (MD) of the preferred group are used, not more than 15 wt % of the dispersions of the non-preferred group may be used.

The basecoat material of the invention comprises at least one specific pigment paste (II).

The paste comprises first of all (IIa) at least one pigment. Of course, however, pigments may additionally be used in another form as well in the basecoat material, as for example in the form of other pastes or dispersions in organic solvents.

Reference here is to conventional pigments imparting color and/or optical effect. Color pigments and effect pigments are known to the skilled person and are described, for example, in Rompp-Lexikon Lacke and Druckfarben, Georg Thieme Verlag, Stuttgart, New York, 1998, pages 176 and 451. The terms “coloring pigment” and “color pigment” are interchangeable, just like the terms “optical effect pigment” and “effect pigment”.

Preferred effect pigments are inorganic effect pigments such as, for example, platelet-shaped metal effect pigments such as lamellar aluminum pigments, gold bronzes, oxidized bronzes and/or iron oxide-aluminum pigments, pearlescent pigments such as pearl essence, basic lead carbonate, bismuth oxide chloride and/or metal oxide-mica pigments and/or other effect pigments such as lamellar graphite, lamellar iron oxide, multilayer effect pigments composed of PVD films and/or liquid crystal polymer pigments. Particularly preferred are platelet-shaped metal effect pigments, more particularly lamellar aluminum pigments.

Typical color pigments include organic and inorganic coloring pigments such as monoazo pigments, disazo pigments, anthraquinone pigments, benzimidazole pigments, quinacridone pigments, quinophthalone pigments, diketopyrrolopyrrole pigments, dioxazine pigments, indanthrone pigments, isoindoline pigments, isoindolinone pigments, azomethine pigments, thioindigo pigments, perinone pigments, perylene pigments, phthalocyanine pigments or aniline black (organic), and also white pigments such as titanium dioxide, zinc white, zinc sulfide or lithopone; black pigments such as carbon black, iron manganese black, or spinel black; chromatic pigments such as chromium oxide, chromium oxide hydrate green, cobalt green or ultramarine green, cobalt blue, ultramarine blue or manganese blue, ultramarine violet or cobalt violet and manganese violet, red iron oxide, cadmium sulfoselenide, molybdate red or ultramarine red; brown iron oxide, mixed brown, spinel phases and corundum phases or chromium orange; or yellow iron oxide, nickel titanium yellow, chromium titanium yellow, cadmium sulfide, cadmium zinc sulfide, chromium yellow or bismuth vanadate (inorganic).

Preferably in the context of the present invention the basecoat material of the invention is an effect basecoat material, hence comprising effect pigments such as, in particular, metallic effect pigments. It is in this way, indeed, that the advantages described at the outset are manifested to very particular effect. However, it is fundamentally advantageous, and in particular is also advantageous in connection with effect basecoat materials, if at least one pigment paste (II) comprises a color pigment. Surprisingly it has emerged that in this way in particular the advantages of the invention are very pronounced. In this case, therefore, the basecoat material comprises at least one color pigment and at least one effect pigment. Further pigments may then be present as desired, in the form for example of further pigment pastes (II) or else as a dispersion in organic solvents.

The preferred effect basecoat materials comprise at least one inorganic effect pigment, preferably a metallic effect pigment, which is used, for example, in the form of a dispersion in or in the form of a mixture with organic solvents or else as a dispersion with wetting additives provided for this purpose in the coating material, and also comprise at least one color pigment, such as a white, black or chromatic pigment, for example, which is used in the form of a paste (II) in the coating material.

The fraction of the pigments is preferably situated in the range from 1.0 to 40.0 wt %, more preferably 2.0 to 35.0 wt %, very preferably 4.0 to 30.0 wt %, based on the total weight of the aqueous basecoat material in each case.

The pigment paste (II) further comprises a specific paste binder (IIb). The paste binder concept is known to the skilled person. It relates to a binder or resin which is used for dispersing the pigments, so that after the dispersing operation these pigments are present in fine distribution in the paste and in that way can be integrated efficiently into the coating material that is ultimately to be produced.

In this connection a brief elucidation may also be given of the fact that the basecoat material comprises a pigment paste (II). It is therefore critical that the components present in the paste are used in the form of the paste (and not, or not only, as such) in the basecoat material, in other words during the production of the formulation.

The paste binder is a polymer of olefinically unsaturated monomers. Corresponding monomers have already been stated in detail above in the context of the description of the dispersion (MD). Accordingly, there is no need to describe them here. The preparation of such polymers by polymerization of the monomers is likewise known. As well as the possibility of emulsion polymerization as already described above, the polymerization can also take place in bulk or in solution in organic solvents, with the latter variant being preferred in connection with the paste binder (IIb). The skilled person knows what type and amount of such solvents are to be used. The same is true of possible polymerization initiators or else of the reaction conditions such as temperature and pressure.

The polymer further comprises (IIb.1) functional groups for nonionic stabilization of the polymer in water. Such groups are known per se and are preferably poly(oxyalkylene) groups, more particularly poly(oxyethylene) groups. There are various ways in which such groups can be introduced, as for example by the copolymerization of monomer components which not only are olefinically unsaturated but also contain groups for nonionic modification. Likewise possible is the retrospective introduction of the groups for nonionic modification, in which case they are then introduced into the polymer covalently by way of mutually reactive groups of a component containing the group for nonionic modification and of the polymer prepared. This pathway is one which is preferred in the context of the present invention, since the compounds needed for this pathway are readily available commercially. Hence it is possible, for example, to copolymerize olefinically unsaturated monomers containing isocyanate groups, such as TMI (dimethylisopropenylbenzyl isocyanate), into the polymer and subsequently to introduce the nonionically stabilizing groups via a urethane formation reaction, by way of polyether diols and/or alkoxypoly(oxyalkylene) alcohols that are known per se. Similar reaction regimes are possible via the introduction of epoxide-functional olefinically unsaturated monomers and subsequent reaction with the aforesaid polyether diols and/or alkoxypoly(oxyalkylene) alcohols.

The polymer further comprises functional groups (IIb.2) selected from the group of silicon-containing, of phosphorus-containing and of urea-containing groups. Without wishing to be tied to any particular theory, it is assumed that these groups exhibit affinity for the pigments to be employed and that therefore in a pigment paste or in a basecoat material produced therefrom they occupy the surface of the pigments and in that way lead to effective dispersion or incorporation of the pigments. While this is a fundamental function of a paste resin, it was nevertheless entirely surprising in this context that a good rheological profile, particularly under low-shear conditions, was obtainable only through the use of the paste resin (II.b) and, accordingly, through the functional groups described here, while at the same time forgoing sizeable amounts of synthetic phyllosilicates, in combination with a microgel dispersion.

On exclusive use of other common paste resins and simultaneous omission of the phyllosilicates, the coating material obtained is significantly too liquid. While such coating materials can be applied to horizontal metal panels, for example, under laboratory conditions, problems nevertheless arise in connection with three-dimensional components comprising vertical regions.

When the paste resins (IIb) and, additionally, the phyllosilicates are employed, the resulting coating material is significantly too viscous. The performance properties, especially the storage stability, the application properties and the leveling, are inadequate.

Preferred embodiments of functional groups (IIb.2) and their incorporation into a copolymer obtained by copolymerization of olefinically unsaturated monomers are described in U.S. Pat. Nos. 5,320,673 and 5,270,399, which are made part of the present specification on the basis in particular of the precise passages of text stated later on below.

Accordingly, preferred embodiments of the functional groups (IIb.2) (identified as “pigment-interactive substituent” in U.S. Pat. Nos. 5,320,673 and 5,270,399) may be described as follows:

Preferred silicon-containing groups are described by the following formula (A):

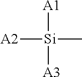

where (A1), (A2) and (A3), in principle independently of one another (for exception see below), are selected from hydroxyl groups, alkyl groups having 1 to 10 carbon atoms, alkoxy groups having 1 to 10 carbon atoms, alkoxyalkoxy groups having 2 to 10 carbon atoms, alkanoyloxy groups having 2 to 10 carbon atoms, and halogen groups, with the proviso that at least one of the groups (A1), (A2) and (A3) is not an alkyl group (exception as stated above).

Preferred phosphorus-containing groups are described by the following formula (B):

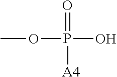

where (A4) is a hydroxyl group, alkyl group having 1 to carbon atoms, alkoxy group having 1 to 10 carbon atoms, alkoxyalkoxy group having 2 to 10 carbon atoms, alkanoyloxy group having 2 to 10 carbon atoms, or a halogen group.

The introduction of these groups into a polymer of olefinically unsaturated monomers may take place differently, for example by the ways described in U.S. Pat. No. 5,320,673. Hence it is possible to introduce the groups directly during the radical copolymerization, specifically by means of monomers which on the one hand have olefinically unsaturated groups and on the other hand have the functional groups (II.b.2) (column 5, line 50 to column 6, line 5 of U.S. Pat. No. 5,320,673). Another possibility is to introduce the groups via a pathway already described above for the groups (II.b.1), namely via the retrospective introduction of the groups. In that case these groups are then introduced into the polymer covalently via mutually reactive groups of a component containing the group (II.b.2) and of the polymer prepared. In particular, a corresponding polymer having free isocyanate groups may be reacted, to form urethane groups, with compounds which contain isocyanate reactive groups (amino groups or hydroxyl groups, for example) and also the groups (II.b.2) (Example 3 of U.S. Pat. No. 5,320,673). Corresponding reaction regimes are possible through introduction of epoxide-functional olefinically unsaturated monomers into the polymer (by means of corresponding monomers) and subsequent reaction with compounds which contain epoxide-functional groups and the groups (II.b.2). One preferred pathway for introducing the phosphorus-containing groups is the reaction of a hydroxy-functional polymer with polyphosphoric acids, by breaking of the P—O—P bridge and corresponding esterification (Example 2 part C of U.S. Pat. No. 5,320,673).

Preferred urea-containing groups (II.b.2) obviously possess a urea group, known per se, and can therefore be described by the following formula (C):

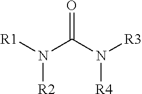

where the radicals R1 to R4, independently of one another (for exception see below), are hydrogen or organic radicals, with the proviso that at least one of the radicals R1 to R4 is divalent and links the urea function to the polymer (exception from above). Corresponding organic radicals may be aliphatic, aromatic, and araliphatic (mixed aliphatic-aromatic). Radicals contemplated include in principle pure hydrocarbon radicals (for example, pure aromatic radicals, alkyl radicals), or they may be substituted by heteroatoms such as oxygen, nitrogen or sulfur. Such heteroatoms may be present in the form of terminal functional groups and, in particular, bridging functional groups. Likewise possible is for two of the radicals R1 to R4 to form a ring structure with one or both nitrogen atoms of the urea group, and preferably, among these, with both nitrogen atoms.

The urea-containing groups (II.b.2) can be introduced in a way which in principle has already been described above. Thus, again, olefinically unsaturated groups may preferably be used with special functional groups such as epoxide groups or isocyanate groups, preferably isocyanate groups, during the preparation of the polymer, and these groups can then be introduced into the polymer retrospectively by compounds containing on the one hand the urea-containing groups (II.b.2) and on the other hand epoxide- and/or isocyanate-reactive groups such as hydroxyl or amino groups.

Compounds preferred in the aforementioned sense are omega-hydroxyalkylalkyleneureas and/or omega-aminoalkylalkyleneureas. Exemplary compounds are 2-hydroxyethylethyleneurea and aminoethylethyleneurea. Paste resins (II.b) prepared accordingly are described in U.S. Pat. No. 5,270,399 in Examples 1 and 5 and also 1 and 6.

The embodiment of the basecoat material of the invention is such that it is possible to do completely without or almost completely without the use of synthetic phyllosilicates. Accordingly, the basecoat material contains less than 0.5 wt % of synthetic phyllosilicates, based on its total weight. It preferably contains less than 0.25 wt %, more preferably less than 0.15 wt %, with further preference less than 0.075 wt %, of synthetic phyllosilicates, based on the total weight of the basecoat material. With very particular preference it is entirely free from such synthetic phyllosilicates.

Nevertheless, or because of the combination with the above-described further features essential to the invention, the outstanding properties described at the outset are obtained.

The aqueous basecoat material preferably further comprises at least one polymer as binder that is different from the polymers present in the microgel dispersion (MD), more particularly at least one polymer selected from the group consisting of polyurethanes, polyesters, polyacrylates and/or copolymers of the stated polymers, more particularly polyester and/or polyurethane polyacrylates. Preferred polyesters are described, for example, in DE 4009858 A1 in column 6, line 53 to column 7, line 61 and column 10, line 24 to column 13, line 3, or WO 2014/033135 A2, page 2, line 24 to page 7, line 10 and page 28, line 13 to page 29, line 13. Preferred polyurethane-polyacrylate copolymers (acrylated polyurethanes) and their preparation are described in, for example, WO 91/15528 A1, page 3, line 21 to page 20, line 33, and DE 4437535 A1, page 2, line 27 to page 6, line 22. The described polymers as binders are preferably hydroxy-functional and especially preferably possess an OH number in the range from 15 to 200 mg KOH/g, more preferably from 20 to 150 mg KOH/g. The basecoat materials more preferably comprise at least one hydroxy-functional polyester.

The proportion of the further polymers as binders may vary widely and is situated preferably in the range from 1.0 to 25.0 wt %, more preferably 3.0 to 20.0 wt %, very preferably 5.0 to 15.0 wt %, based in each case on the total weight of the basecoat material.

The basecoat material according to the invention may further comprise at least one typical crosslinking agent known per se. If it comprises a crosslinking agent, said agent comprises preferably at least one aminoplast resin and/or at least one blocked polyisocyanate, preferably an aminoplast resin. Among the aminoplast resins, melamine resins in particular are preferred.

If the basecoat material does comprise crosslinking agents, the proportion of these crosslinking agents, more particularly aminoplast resins and/or blocked polyisocyanates, very preferably aminoplast resins and, of these, preferably melamine resins, is preferably in the range from 0.5 to 20.0 wt %, more preferably 1.0 to 15.0 wt %, very preferably 1.5 to 10.0 wt %, based in each case on the total weight of the basecoat material.

The basecoat material may further comprise at least one organic thickener, as for example a (meth)acrylic acid-(meth)acrylate copolymer thickener or a polyurethane thickener. Employed for example here may be conventional organic associative thickeners, such as the known associative polyurethane thickeners, for example. Associative thickeners, as is known, are termed water-soluble polymers which have strongly hydrophobic groups at the chain ends or in side chains, and/or whose hydrophilic chains contain hydrophobic blocks or concentrations in their interior. As a result, these polymers possess a surfactant character and are capable of forming micelles in aqueous phase. In similarity with the surfactants, the hydrophilic regions remain in the aqueous phase, while the hydrophobic regions enter into the particles of polymer dispersions, adsorb on the surface of other solid particles such as pigments and/or fillers, and/or form micelles in the aqueous phase. Ultimately a thickening effect is achieved, without any increase in sedimentation behavior.

Thickeners as stated are available commercially. The proportion of the thickeners is preferably in the range from 0.1 to 5.0 wt %, more preferably 0.2 to 3.0 wt %, very preferably 0.3 to 2.0 wt %, based in each case on the total weight of the basecoat material.

Furthermore, the basecoat material may further comprise at least one further adjuvant. Examples of such adjuvants are salts which are thermally decomposable without residue or substantially without residue, polymers as binders that are curable physically, thermally and/or with actinic radiation and that are different from the polymers already stated as binders, further crosslinking agents, organic solvents, reactive diluents, transparent pigments, fillers, molecularly dispersely soluble dyes, nanoparticles, light stabilizers, antioxidants, deaerating agents, emulsifiers, slip additives, polymerization inhibitors, initiators of radical polymerizations, adhesion promo-ters, flow control agents, film-forming assistants, sag control agents (SCAs), flame retardants, corrosion inhibitors, waxes, siccatives, biocides, and matting agents. Such adjuvants are used in the customary and known amounts.

The solids content of the basecoat material may vary according to the requirements of the case in hand. The solids content is guided primarily by the viscosity that is needed for application, more particularly spray application. A particular advantage is that the basecoat material for inventive use, at comparatively high solids contents, is able nevertheless to have a viscosity which allows appropriate application.

The solids content of the basecoat material is preferably at least 16.5%, more preferably at least 18.0%, even more preferably at least 20.0%.

Under the stated conditions, in other words at the stated solids contents, preferred basecoat materials have a viscosity of 40 to 150 mPa·s, more particularly to 120 mPa·s, at 23° C. under a shearing load of 1000 l/s (for further details regarding the measurement method, see Examples section). For the purposes of the present invention, a viscosity within this range under the stated shearing load is referred to as spray viscosity (working viscosity). As is known, coating materials are applied at spray viscosity, meaning that under the conditions then present (high shearing load) they possess a viscosity which in particular is not too high, so as to permit effective application. This means that the setting of the spray viscosity is important, in order to allow a paint to be applied at all by spray methods, and to ensure that a complete, uniform coating film is able to form on the substrate to be coated.

The basecoat material for inventive use is aqueous (regarding the fundamental definition of “aqueous”, see above).

The fraction of water in the basecoat material is preferably from 35 to 70 wt %, and more preferably 45 to 65 wt %, based in each case on the total weight of the basecoat material.

Even more preferred is for the percentage sum of the solids content of the basecoat material and the fraction of water in the basecoat material to be at least 70 wt %, preferably at least 75 wt %. Among these figures, preference is given to ranges of 75 to 95 wt %, in particular 80 to 90 wt %.

This means in particular that preferred basecoat materials comprise components that are in principle a burden on the environment, such as organic solvents in particular, in relation to the solids content of the basecoat material, at only low fractions. The ratio of the volatile organic fraction of the basecoat material (in wt %) to the solids content of the basecoat material (in analogy to the representation above, here in wt %) is preferably from 0.05 to 0.7, more preferably from 0.15 to 0.6. In the context of the present invention, the volatile organic fraction is considered to be that fraction of the basecoat material that is considered neither part of the water fraction nor part of the solids content.

Another advantage of the basecoat material is that it can be prepared without the use of eco-unfriendly and health-injurious organic solvents such as N-methyl-2-pyrrolidone, dimethylformamide, dioxane, tetrahydrofuran, and N-ethyl-2-pyrrolidone. Accordingly, the basecoat material preferably contains less than 10 wt %, more preferably less than 5 wt %, more preferably still less than 2.5 wt % of organic solvents selected from the group consisting of N-methyl-2-pyrrolidone, dimethylformamide, dioxane, tetrahydrofuran, and N-ethyl-2-pyrrolidone. The basecoat material is preferably entirely free from these organic solvents.

The basecoat materials can be produced using the mixing assemblies and mixing techniques that are customary and known for the production of basecoat materials.

Further provided by the present invention is a method for producing a multicoat paint system, which involves producing at least one basecoat film using at least one aqueous basecoat material of the invention.

All of the statements made above concerning the basecoat material of the invention are also valid for the method of the invention. This is the case in particular not least for all preferred, more preferred, and very preferred features.

Provided accordingly by the present invention is a method in which
(1) an aqueous basecoat material is applied to a substrate,
(2) a polymer film is formed from the coating material applied in stage (1),
(3) a clearcoat material is applied to the resulting basecoat film, and then
(4) the basecoat film is cured together with the clearcoat film, wherein the aqueous basecoat material used in stage (1) is a basecoat material of the invention.

The stated method is used preferably to produce multicoat color paint systems, effect paint systems, and color and effect paint systems.

The aqueous basecoat material for inventive use is commonly applied to metallic or plastics substrates that have been pretreated with surfacer or primer-surfacer. Optionally said basecoat material may also be applied directly to the plastics substrate.

Where a metal substrate is to be coated, it is preferably coated additionally with an electrocoat system before the surfacer or primer-surfacer is applied.

Where a plastics substrate is being coated, it is preferably given, additionally, a surface-activating pretreatment before the surfacer or primer-surfacer is applied. The methods most commonly used for such pretreatment are flaming, plasma treatment, corona discharge. Flaming is used with preference.

Application of the aqueous basecoat material of the invention to a metal substrate may take place in the film thicknesses customary in the automobile industry in the range from, for example, 5 to 100 micrometers, preferably 5 to 60 micrometers. This is done using spray application methods, such as, for example, compressed air spraying, airless spraying, high-speed rotation, electrostatic spray application (ESTA), alone or in conjunction with hot spray application such as hot air spraying, for example. Application here may take place in one, two or more, spray pass(es).

After the aqueous basecoat material has been applied, it can be dried by known methods. For example, (one-component) basecoat materials, which are preferred, may be flashed at room temperature for 1 to 60 minutes and subsequently dried, preferably at optionally slightly elevated temperatures of 30 to 90° C. Flashing and drying in the context of the present invention may be evaporation of organic solvents and/or water, as a result of which the paint becomes drier but has not yet cured or not yet formed a fully crosslinked coating film.

Then a commercial clearcoat material is applied, by likewise common methods, the film thicknesses again being within the usual ranges, of 5 to 100 micrometers for example. Two-component clearcoat materials are preferred.

After the clearcoat material has been applied, it can be flashed at room temperature for 1 to 60 minutes, for example, and optionally dried. The clearcoat material is then cured together with the applied basecoat material. Here, for example, crosslinking reactions take place, producing a multicoat color and/or effect paint system of the invention on a substrate. Curing takes place preferably thermally at temperatures of 60 to 200° C.

All of the film thicknesses reported in the context of the present invention are understood as dry film thicknesses. The film thickness is therefore that of the cured coat in each case. Where, then, it is reported that a coating material is applied in a particular film thickness, this means that the coating material is applied in such a way that the stated film thickness is achieved after curing.

Plastics substrates are coated basically in the same way as for metal substrates. Here, however, curing takes place generally at much lower temperatures, of 30 to 90° C., so as not to cause damage and/or deformation of the substrate.

By means of the method of the invention, therefore, it is possible for metallic and nonmetallic substrates, especially plastics substrates, preferably automobile bodies or parts thereof, to be painted.

In one particular embodiment of the method of the invention, one fewer curing step is carried out in comparison to a standard procedure, as already described at the outset. This means in particular that a coating system for joint curing, comprising one or at least two basecoat films, in other words, at any rate, a first basecoat material and a second basecoat material, and also a clearcoat material, is built up on a substrate and then jointly cured. At least one of the basecoat materials used in this system is a basecoat material of the invention. In a system comprising at least two basecoat films, therefore, the first basecoat material or the second basecoat material may be a basecoat material of the invention. Equally possible, and within the present invention, is for both basecoat materials to be basecoat materials of the invention. The system described here is built up, for example, on a plastics substrate which has optionally been given a surface-activating pretreatment, or on a metal substrate provided with a cured electrocoat system.

Particularly preferred in this case is construction on metal substrates provided with a cured electrocoat film. In this embodiment, therefore, it is critical that all of the coating compositions applied to the cured electrocoat system are jointly cured. Although, of course, separate flashing and/or interim drying is possible, none of the films is converted into the cured state separately.

Curing and cured state are understood for the purposes of the present invention in accordance with their general interpretation by a skilled person. Accordingly, the curing of a coating film means the conversion of such a film into the ready-to-use state, in other words into a state in which the substrate equipped with the coating film in question can be transported, stored, and put to its intended use. A cured coating film, therefore, in particular is no longer soft or tacky, but is instead conditioned as a solid coating film, which no longer undergoes any substantial alteration in its properties such as hardness or substrate adhesion, even when further exposed to curing conditions as described later on below.

In the context of the method described it is preferred for the basecoat material to be applied exclusively by electrostatic spray application. As is known, and as was also described at the outset, this mode of application is very economical with material. With systems of the prior art, however, success is generally not achieved in obtaining effective alignment of the effect pigments in the case of coating materials containing effect pigment, if application takes place solely by electrostatic spray application. Instead, in general, a concluding application pass by pneumatic application is required.

It follows from the above that within the method of the invention, preference is given to using an effect pigment-containing basecoat material which is applied exclusively by electrostatic spray application.

Using the basecoat materials of the invention results in multicoat paint systems which exhibit excellent esthetic qualities. A further factor is that the storage stability of the coating materials is outstanding. All this is achieved despite the complete or near-complete absence in the coating materials of synthetic phyllosilicates.

### EXAMPLES

### A Description of Methods

1. Solids Content (Solids, Nonvolatile Fraction)

The nonvolatile fraction is determined according to DIN EN ISO 3251 (date: June 2008). This involves weighing out 1 g of sample into an aluminum dish which has been dried beforehand, drying it in a drying oven at 125° C. for 60 minutes, cooling it in a desiccator, and then reweighing it. The residue relative to the total amount of sample used corresponds to the nonvolatile fraction. The volume of the nonvolatile fraction may optionally be determined if necessary according to DIN 53219 (date: August 2009).

2. Film Thicknesses

The film thicknesses are determined according to DIN EN ISO 2808 (date: May 2007), method 12A, using the MiniTest® 3100-4100 instrument from ElektroPhysik.

3. Determination of Lightness and Flop Index

For determining the lightness or the flop index, a coating material is applied as waterborne basecoat material to a steel panel, coated with a surfacer coating and measuring 32×60 cm, by means of dual electrostatic application so as to give a total film thickness (dry film thickness) of 12-17 μm.

The first application step here is followed by a three-minute flash phase at room temperature (18 to 23° C.); subsequently a further electrostatic application step is carried out, and the resulting waterborne basecoat film is flashed at room temperature for 10 minutes and then dried at 80° C. in a forced air oven for a further 10 minutes.

Applied atop the dry waterborne basecoat film is a commercial two-component clearcoat material (ProGloss® from BASF Coatings GmbH) with a dry film thickness of 40-45 μm. The resulting clearcoat film is flashed at room temperature (18 to 23° C.) for a time of 10 minutes. This is followed by curing in a forced air oven at 140° C. for a further 20 minutes. The substrate coated accordingly is subjected to measurement using an X-Rite spectrophotometer (X-Rite MA68 Multi-Angle Spectrophotometer). Here, the surface is illuminated with a light source. Spectral detection is carried out in the visible range, from different angles. The spectral measurements obtained in this way can be used, taking into account the standardized spectral values and also the reflection spectrum of the light source used, to calculate color values in the CIEL*a*b* color space, where L* characterizes the lightness, a* the red-green value, and b* the yellow-blue value. This method is described for example in ASTM E2194-12 particularly for coatings whose pigment comprises at least one effect pigment. The derived value, often employed to quantify the so-called metallic effect, is the so-called flop index, which describes the relationship between the lightness and the angle of observation (compare A. B. J. Rodriguez, JOCCA, 1992 (4), pp. 150-153). From the lightness values determined for the viewing angles of 15°, 45°, and 110°, it is possible to calculate the flop index (FL) according to the formula

FL=2.69(L*₁₅−L*_{110°})^{1.11}/(L*_{45°})^{0.86},

where L* is the lightness value measured at the respective measurement angle (15°, 45°, and 110°).

4. Determination of Low-Shear and High-Shear Viscosity

The low-shear and high-shear viscosities are determined using a rotational viscometer corresponding to DIN 53019-1 (date: September 2008) and calibrated according to DIN 53019-2 (date: February 2001) under normalized conditions (23.0° C.±0.2° C.). The corresponding samples are subjected to shearing first for 5 minutes with a shear rate of 1000 s⁻¹ (load phase) and then for 8 minutes at a shear rate of 1 s⁻¹ (unload phase). The average viscosity level during the load phase (high-shear viscosity) and also the level after 8 minutes of unload phase (low-shear viscosity) are determined from the measurement data. The determination of the viscosity level after different storage times and treatment times, and comparison of the values with one another, provides information about the storage stability (see 5.)).

5.) Determination of Stability after Oven Storage/Stirring Test

To determine the storage stability of coating materials, they are investigated before and after storage at 40° C. for a certain time, and before and after a stirring test (700 g of material are stirred at a stirring speed n of 20 min⁻¹ in a 1 L metal can internally coated and closed with a lid, for 21 days in a mixing frame) using a rotational viscometer corresponding to DIN 53019-1 (date: September 2008) and calibrated according to DIN 53019-2 (date: February 2001) under normalized conditions (23.0° C.±0.2° C.), in accordance with the method described under 4). The values before and after loading are then compared with one another, by calculating the respective percentage changes.

6.) Assessment of Film Thickness-Dependent Leveling

To assess the film thickness-dependent leveling, wedge-shaped multicoat paint systems are produced according to the following general protocols:

A steel panel with dimensions of 30×50 cm, coated with a standard cathodic electrocoat (CathoGuard® 800 from BASF Coatings), is provided on one long edge with an adhesive strip (Tesaband, 19 mm), to allow determination of differences in film thickness after coating.

The waterborne basecoat material is applied electrostatically as a wedge with a target film thickness (film thickness of the dry material) of 0-40 μm. After a flashing time of 4-5 minutes at room temperature, the system is dried in a forced air oven at 60° C. for 10 minutes.

Following removal of the adhesive strip, a commercial two-component clearcoat material (ProGloss® from BASF Coatings GmbH) is applied manually to the dried waterborne basecoat film, using a gravity-fed cup-type gun, with a target film thickness (film thickness of the dried material) of 40-45 μm. The resulting clearcoat film is flashed off at room temperature (18 to 23° C.) for 10 minutes; this is followed by curing in a forced air oven at 140° C. for a further 20 minutes.

The multicoat paint systems are evaluated according to the following general protocol:

The dry film thickness of the overall waterborne basecoat material is checked and for the basecoat film thickness wedge, for example, the regions of 15-20 μm and also 20-25 μm and/or 10-15 μm, 15-20 μm, 20-25 μm, 25-30 μm, and optionally 30-35 μm are marked on the steel panel.

The film thickness-dependent leveling is determined or assessed by means of the Wave scan instrument from Byk/Gardner within the four previously ascertained basecoat film thickness regions. For this purpose a laser beam is directed at an angle of 60° onto the surface under investigation, and the fluctuations in the reflected light are recorded over a distance of 10 cm in the shortwave region (0.3 to 1.2 mm) and in the longwave region (1.2 to 12 mm) by means of the instrument (long wave=LW; short wave=SW; the lower the values, the better the appearance). Moreover, as a measure of the sharpness of an image reflected in the surface of the multicoat system, the parameter of “distinctness of image” (DOI) is determined by means of the instrument (the higher the value, the better the appearance).

7. Average Particle Size of the Particles in the dispersion (MD) The average particle size (volume average) of the polymer particles present in the dispersions (MD) for inventive use is determined for the purposes of the present invention by photon correlation spectroscopy (PCS) in a method based on DIN ISO 13321.

Employed specifically for the measurement was a “Malvern Nano S90” (from Malvern Instruments) at 25±1° C. The instrument covers a size range from 3 to 3000 nm and was equipped with a 4 mW He—Ne laser at 633 nm. The dispersions (MD) were diluted with a dispersion medium consisting of particle-free, deionized water, before being subjected to measurement in a 1 ml polystyrene cell at suitable scattering intensity. Evaluation took place using a digital correlator with the assistance of version 7.11 of the Zetasizer software (from Malvern Instruments). Measurement took place five times, and the measurements were repeated on a second, freshly prepared sample. The standard deviation of a five-fold determination was 4%. The maximum deviation in the arithmetic mean of the volume average (V-average mean) of five individual measurements was ±15%. The stated average particle size (volume average) is the arithmetic mean of the average particle size (volume average) of the individual preparations. Verification took place using polystyrene standards having certified particle sizes between 50 to 3000 nm.

8. Gel Fraction

The gel fraction in the context of the present invention is determined gravimetrically. In this case first of all the polymer present was isolated by freeze drying from a sample, more particularly from an aqueous dispersion (MD), (initial mass 1.0 g). Following determination of the solidification temperature, the temperature at which the electrical resistance of the sample shows no further change when the temperature is lowered further, the fully frozen sample underwent primary drying, customarily in the pressure range of the drying vacuum of between 5 mbar and 0.05 mbar, at a drying temperature 10° C. lower than the solidification temperature. By gradually raising the temperature of the heated placement surfaces to 25° C., rapid freeze-drying of the polymers was achieved; after a drying time of typically 12 hours, the amount of isolated polymer (solid fraction, determined via the freeze drying) was constant and did not show any further change even when freeze drying was prolonged. By subsequent drying at a placement-surface temperature of 30° C. under maximally reduced ambient pressure (customarily between 0.05 and 0.03 mbar), optimum drying of the polymer was achieved.

The isolated polymer was subsequently sintered in a forced air oven at 130° C. for one minute and thereafter extracted for 24 hours at 25° C. in an excess of tetrahydrofuran (ratio of tetrahydrofuran to solid fraction=300:1). The insoluble fraction of the isolated polymer (gel fraction) was then separated off on a suitable frit, dried in a forced air oven at 50° C. for 4 hours, and then reweighed.

Additionally, it was ensured that the gel fraction found for the microgel particles is independent of the sintering time at the sintering temperature of 130° C. and with variation of the sintering times between one minute and twenty minutes. This rules out any further increase in the gel fraction in the case of crosslinking reactions occurring after the isolation of the polymeric solid.

The gel fraction determined in this way in accordance with the invention can also be reported in wt %. This is because, evidently, the gel fraction is the fraction of polymer particles, based on the weight, which has crosslinked as described at the outset in connection with the dispersion (MD) and which can therefore be isolated as a gel.

### B Working Examples

The inventive and comparative examples below serve to elucidate the invention, but should not be interpreted as imposing any restriction.

Unless otherwise indicated, the amounts in parts are parts by weight, and amounts in percent are in each case percentages by weight.

1 Preparation of a Microgel Dispersion (MD1)

The components identified below and used in preparing the aqueous microgel dispersion (MD1) have the following meaning:
DMEA dimethylethanolamine
DI water deionized water
EF 800 Aerosol® EF-800, commercially available emulsifier from Cytec
APS ammonium peroxodisulfate
1,6-HDDA 1,6-hexanediol diacrylate
2-HEA 2-hydroxyethyl acrylate
MMA methyl methacrylate

Monomer Mixture (A), Stage i.

80 wt % of items 1 and 2 from table 1.1 are introduced into a steel reactor (5 L volume) with reflux condenser and heated to 80° C. The remaining fractions of the components listed under “Initial charge” in table 1.1 are premixed in a separate vessel. This mixture and, separately from it, the initiator solution (table 1.1, items 5 and 6) are added dropwise simultaneously to the reactor over the course of 20 minutes, with a fraction of the monomers in the reaction solution, based on the total amount of monomers used in stage i., not exceeding 6.0 wt % throughout the entire reaction time. Subsequently, stirring takes place for 30 minutes.

Monomer Mixture (B), Stage ii.

The components indicated under “Mono 1” in table 1.1 are premixed in a separate vessel. This mixture is added dropwise to the reactor over the course of 2 hours, with a fraction of the monomers in the reaction solution, based on the total amount of monomers used in stage ii., not exceeding 6.0 wt % throughout the entire reaction time. Subsequently, stirring is carried out for 1 hour.

Monomer Mixture (C), Stage iii.

The components indicated under “Mono 2” in table 1.1 are premixed in a separate vessel. This mixture is added dropwise to the reactor over the course of 1 hour, with a fraction of the monomers in the reaction solution, based on the total amount of monomers used in stage iii., not exceeding 6.0 wt % throughout the entire reaction time. Subsequently, stirring is carried out for 2 hours. Thereafter the reaction mixture is cooled to 60° C. and the neutralizing mixture (table 1.1, items 20, 21, and 22) is premixed in a separate vessel. The neutralizing mixture is added dropwise to the reactor over the course of 40 minutes, during which the pH of the reaction solution is adjusted to a value of 7.5 to 8.5. The reaction product is subsequently stirred for 30 minutes more, cooled to 25° C., and filtered.

TABLE 1.1
Aqueous microgel dispersion (MD1)
comprising a multistage polyacrylate

| | | (MD1) |
|---|---|---|
| | Initial charge | |
| 1 | DI water | 41.81 |
| 2 | EF 800 | 0.18 |
| 3 | Styrene | 0.68 |
| 4 | n-butyl acrylate | 0.48 |
| | Initiator solution | |
| 5 | DI water | 0.53 |
| 6 | APS | 0.02 |
| | Mono 1 | |
| 7 | DI water | 12.78 |
| 8 | EF 800 | 0.15 |
| 9 | APS | 0.02 |
| 10 | Styrene | 5.61 |
| 11 | n-butyl acrylate | 13.6 |
| 12 | 1,6-HDDA | 0.34 |
| | Mono 2 | |
| 13 | DI water | 5.73 |
| 14 | EF 800 | 0.07 |
| 15 | APS | 0.02 |
| 16 | Methacrylic acid | 0.71 |
| 17 | 2-HEA | 0.95 |
| 18 | n-butyl acrylate | 3.74 |
| 19 | MMA | 0.58 |
| | Neutralization | |
| 20 | DI water | 6.48 |
| 21 | Butyl glycol | 4.76 |
| 22 | DMEA | 0.76 |

The solids content of the aqueous dispersion (MD1) was determined for the purpose of reaction monitoring. The result is reported, together with the pH and the ascertained particle size, in table 1.2. Also reported is the gel fraction of the polymer present.

TABLE 1.2
Characteristics of the
aqueous microgel (MD1)

| | (MD1) |
|---|---|
| Solids content [%] | 25.6 |
| pH | 8.85 |
| Particle size [nm] | 246 |
| Gel fraction | 85% |

2 Preparation of Paste Binders (IIb)

(IIb-1)

The paste binder (IIb-1) is prepared in accordance with example 5, column 10, lines 26 to 48 of patent application U.S. Pat. No. 5,270,399. The resulting polymer, however, is dispersed not, as described in that example, in 10 g of water, but instead in a mixture of n-butanol, Dowanolm PnP glycol ether (available from Dow Chemical), and deionized water in a ratio of 5:45:50, to give a solids content of 35±2 wt %.

(IIb-2)

The paste binder (IIb-2) is prepared in accordance with example 2, column 17, line 53 to column 18, line 29 of patent application U.S. Pat. No. 5,320,673; however, the isocyanate-functionalized acrylate described in “Part A. Synthesis of Polymeric Backbone” is replaced by the isocyanate-functionalized acrylate of example 1, column 9, lines 10 to 29 of patent application U.S. Pat. No. 5,270,399. The phosphate-functionalized polymer is subsequently dispersed in a mixture of Dowanolm PnP glycol ether (available from Dow Chemical) and deionized water in a ratio of 1:1, to give a solids content of 35±2 wt %.

3 Production of Mixing Varnishes and Pigment Pastes (II)

Mixing Varnish MV-1

In accordance with patent specification EP 1534792-B1, column 11, lines 1-13, 81.9 parts by weight of deionized water, 2.7 parts by weight of Rheovis® AS 1130 (available from BASF SE), 8.9 parts by weight of 2,4,7,9-tetramethyl-5-decynediol, 52% in BG (available from BASF SE), 3.2 parts by weight of Dispex Ultra FA 4437 (available from BASF SE) and 3.3 parts by weight of 10% dimethylethanolamine in water are mixed with one another; the resulting mixture is subsequently homogenized.

Pigment paste white (comparative 1) The white paste (comparative 1) is produced from 50 parts by weight of a rutile titanium dioxide pigment, produced in a chloride process (for example, Titan Rutil 2310, available from Kronos, or Ti-Pure™ R-706, available from Chemours), 6 parts by weight of a polyester prepared according to example D, column 16, lines 37-59 of DE 40 09 858 A1, 24.7 parts by weight of a binder dispersion prepared as per patent application EP 022 8003 B2, page 8, lines 6 to 18, 10.5 parts by weight of deionized water, 4 parts by weight of 2,4,7,9-tetramethyl-5-decynediol, 52% in BG (available from BASF SE), 4.1 parts by weight of butyl glycol, 0.4 part by weight of 10% dimethylethanolamine in water, and 0.3 part by weight of Acrysol RM-8 (available from The Dow Chemical Company).

Pigment Paste White (II-1)

The white paste (II-1) is produced from 69 parts by weight of a rutile titanium dioxide pigment (pigment (IIa)), produced in a chloride process (for example, Titan Rutil 2310, available from Kronos or Ti-Pure™ R-706, available from Chemours), 6.2 parts by weight of the binder (IIb-2), 1.2 parts by weight of Dowanolm PnP glycol ether (available from Dow Chemical), and 23.6 parts by weight of deionized water.

Pigment Paste Blue (Comparative 2)

The blue paste (comparative 2) was produced from 69.8 parts by weight of a polyurethane dispersion prepared as per WO 92/15405, page 13, line 13 to page 15, line 13, 12.5 parts by weight of Paliogen® Blue L 6482 (available from BASF SE), 1.5 parts by weight of 10% strength aqueous dimethylethanolamine solution, 1.2 parts by weight of a commercial polyether (Pluriol® P900, available from BASF SE), and 15 parts by weight of deionized water.

Pigment Paste Blue (II-2)

The blue paste (II-2) was produced from 14.28 parts by weight of Paliogen® Blue L 6482 (available from BASF SE), 19.04 parts by weight of the binder (IIb-1), 8.57 parts by weight of Dowanol™ PnP glycol ether (available from Dow Chemical), 0.5 part by weight of a 20% solution of dimethylethanolamine in water, and 57.61 parts by weight of deionized water.

4 Production of Waterborne Basecoat Materials

4.1 Production of the Noninventive Waterborne Basecoat Materials WBM1 and WBM2 and of the Inventive Waterborne Basecoat Material WBM3

The compounds listed under “Aqueous Phase” in table 4.1 are stirred together in the order stated to form an aqueous mixture. This mixture is then stirred for 10 minutes and adjusted, using deionized water and dimethylethanolamine, to a pH of 8.2 and a spray viscosity of 85±5 mPa·s at a shearing load of 1000 s⁻¹, measured with a rotational viscometer (Rheolab QC instrument with C-LTD80/QC conditioning system from Anton Paar) at 23° C.

TABLE 4.1
Production of waterborne basecoat materials
WBM1, WBM2 (not inventive) and WBM3 (inventive)

| Aqueous phase: | WBM1 | WBM2 | WBM3 |
|---|---|---|---|
| 3% Na Mg phyllosilicate solution | 14.8 | | |
| deionized water | 8.7 | 8.7 | 21.4 |
| 2-ethylhexanol | 1.5 | 1.5 | 1.5 |
| Aqueous binder dispersion (MD1) | 26.9 | 26.9 | 26.9 |
| Polyester; prepared as per page 28, | | | |
| lines 13 to 33 (Example BE1) of | 2.3 | 2.3 | 2.3 |
| WO 2014/033135 A2 | | | |
| Melamine-formaldehyde resin | 5.1 | 5.1 | 5.1 |
| (Cymel ® 203 from Allnex) | | | |
| 10% dimethylethanolamine in water | 0.1 | 0.1 | 0.1 |
| 2,4,7,9-tetramethyl-5-decynediol, | 0.3 | 0.3 | 0.3 |
| 52% in BG (available from BASF SE) | | | |
| Rheovis ® AS 1130 available from | 0.2 | 0.2 | 0.2 |
| BASF SE | | | |
| deionized water | 0.7 | 0.7 | 0.7 |
| Butyl glycol | 3.0 | 3.0 | 3.0 |
| 50 wt % solution of Rheovis ® PU1250 | 0.1 | 0.1 | 0.1 |
| in butyl glycol (Rheovis ® PU1250 | | | |
| available from BASF SE) | | | |
| White paste (comparative 1) | 36.4 | 36.4 | |
| White paste (II-1) | | | 21.4 |
| Pigment/binder ratio: | 1.05 | 1.05 | 1.05 |

4.2 Production of the Noninventive Waterborne Basecoat Materials WBM4 and WBM5 and of the Inventive Waterborne Basecoat Material WBM6

The compounds listed under “Aqueous Phase” in table 4.2 are stirred together in the order stated to form an aqueous mixture. In the next step, a mixture is produced from the components listed under “Aluminum pigment premix”. This mixture is added to the aqueous mixture. This mixture is then stirred for 10 minutes and adjusted, using deionized water and dimethylethanolamine, to a pH of 8.2 and a spray viscosity of 80±5 mPa·s at a shearing load of 1000 s⁻¹, measured with a rotational viscometer (Rheolab QC instrument with C-LTD80/QC conditioning system from Anton Paar) at 23° C.

TABLE 4.2
Production of waterborne basecoat materials
WBM4, WBM5 (not inventive) and WBM6
(inventive) WBM4 WBM5 WBM6

| Aqueous phase: | | | |
|---|---|---|---|
| 3% Na Mg phyllosilicate solution | 14.8 | | |
| deionized water | 8.7 | 8.7 | 11.2 |
| 2-ethylhexanol | 1.5 | 1.5 | 1.9 |
| Aqueous binder dispersion (MD1) | 26.9 | 26.9 | 34.6 |
| Polyester; prepared as per page 28, | 2.3 | 2.3 | 2.9 |
| lines 13 to 33 (Example BE1) | | | |
| WO 2014/033135 A2 | | | |
| Melamine-formaldehyde resin | 5.1 | 5.1 | 6.6 |
| (Cymel ® 203 from Allnex) | | | |
| 10% dimethylethanolamine in water | 0.2 | 0.1 | 0.2 |
| 2,4,7,9-tetramethy1-5-decynediol, | 0.3 | 0.3 | 0.4 |
| 52% in BG (available from BASF SE) | | | |
| Rheovis ® AS 1130 available from | 0.2 | 0.2 | |
| BASF SE | | | |
| deionized water | 0.7 | 0.7 | |
| Butyl glycol | 3.0 | 3.0 | 3.8 |
| 50 wt % solution of Rheovis ® PU1250 | 0.1 | 0.1 | |
| in butyl glycol (Rheovis ® PU1250 | | | |
| available from BASF SE) | | | |
| Blue paste (comparative 2) | 24.6 | 24.5 | |
| Blue paste (II-2) | | | 22.4 |
| Aluminum pigment premix: | | | |
| Mixing varnish MV1 | 6.1 | 6.1 | 6.1 |
| Commercial aluminum pigment, | 2.0 | 2.0 | 2.0 |
| available from Altana-Eckart | | | |
| (Alu Stapa Hydrolux 2154) | | | |
| Pigment/binder ratio: | 0.25 | 0.25 | 0.25 |

4.3 Production of the Noninventive Waterborne Basecoat Materials WBM7 and WBM9 and of the Inventive Waterborne Basecoat Materials WBM8 and WBM10

The compounds listed under “Aqueous Phase” in table 4.3 are stirred together in the order stated to form an aqueous mixture. In the next step, a mixture is produced from the components listed under “Aluminum pigment premix”. This mixture is added to the aqueous mixture. This mixture is then stirred for 10 minutes and adjusted, using deionized water and dimethylethanolamine, to a pH of 8.2 and a spray viscosity of 85±5 mPa·s at a shearing load of 1000 s⁻¹, measured with a rotational viscometer (Rheolab QC instrument with C-LTD80/QC conditioning system from Anton Paar) at 23° C.

TABLE 4.3
Production of waterborne basecoat materials
WBM7 and WMB9 (not inventive) and
WBM8 and WBM10 (inventive)

| | WBM7 | WBM8 | WBM9 | WBM10 |
|---|---|---|---|---|
| Aqueous phase: | | | | |
| 3% Na Mg phyllosilicate | 10.7 | | 7.1 | |
| solution | | | | |
| deionized water | 8.0 | 10.3 | 5.8 | 7.4 |
| 2-ethylhexanol | 1.4 | 1.8 | 1.4 | 1.8 |
| Aqueous binder dispersion | 19.4 | 24.9 | 13.0 | 16.6 |
| (MD1) | | | | |
| Aqueous polyurethane- | 4.5 | 5.7 | 8.9 | 11.4 |
| polyurea dispersion, | | | | |
| prepared as per page 49, | | | | |
| line 29 to page 51, line 29 | | | | |
| (Example D1) of patent | | | | |
| specification | | | | |
| WO 2016/091539 A1 | | | | |
| Polyester; prepared as per | 2.2 | 2.8 | 2.2 | 2.8 |
| page 28, lines 13 to 33 | | | | |
| (Example BE1) | | | | |
| WO 2014/033135 A2 | | | | |
| Melamine-formaldehyde resin | 4.9 | 6.3 | 4.9 | 6.3 |
| (Cymel ® 203 from Allnex) | | | | |
| 10% dimethylethanolamine in | 0.1 | 0.2 | 0.1 | 0.2 |
| water | | | | |
| 2,4,7,9-tetramethy1-5- | 0.2 | 0.3 | 0.1 | 0.2 |
| decynediol, 52% in BG | | | | |
| (available from BASF SE) | | | | |
| Rheovis ® AS 1130 available | 0.2 | | 0.2 | |
| from BASF SE | | | | |
| deionized water | 0.7 | | 0.7 | |
| Butyl glycol | 2.8 | 3.7 | 2.9 | 3.7 |
| 50 wt % solution of Rheovis ® | 0.1 | | 0.1 | |
| PU1250 in butyl glycol | | | | |
| (Rheovis ® PU1250 available | | | | |
| from BASF SE) | | | | |
| Blue paste (comparative 2) | 23.6 | | 23.6 | |
| Blue paste (II-2) | | 21.5 | | 21.5 |
| Aluminum pigment premix: | | | | |
| Mixing varnish MV1 | 5.9 | 5.9 | 5.9 | 5.9 |
| Commercial aluminum pigment, | | | | |
| available from Altana-Eckart | 2.0 | 2.0 | 2.0 | 1.9 |
| (Alu Stapa Hydrolux 2154) | | | | |
| Pigment/binder ratio: | 0.25 | 0.25 | 0.25 | 0.25 |

4.4 Production of the Noninventive Waterborne Basecoat Material WBM11

The compounds listed under “Aqueous Phase” in table 4.4 are stirred together in the order stated to form an aqueous mixture. In the next step, a mixture is produced from the components listed under “Aluminum pigment premix”. This mixture is added to the aqueous mixture. This mixture is then stirred for 10 minutes and adjusted, using deionized water and dimethylethanolamine, to a pH of 8.2 and a spray viscosity of 85±5 mPa·s at a shearing load of 1000 s⁻¹, measured with a rotational viscometer (Rheolab QC instrument with C-LTD80/QC conditioning system from Anton Paar) at 23° C.

TABLE 4.4
Production of waterborne basecoat
materials WBM11 (not inventive)

| | WBM11 |
|---|---|
| Aqueous phase: | |
| 3% Na Mg phyllosilicate solution | 17.1 |
| deionized water | 10.1 |
| 2-ethylhexanol | 1.7 |
| Aqueous binder dispersion (MD1) | 31.2 |
| Polyester; prepared as per page 28, | 2.7 |
| lines 13 to 33 (Example BE1) | |
| WO 2014/033135 A2 | |
| Melamine-formaldehyde resin | 5.9 |
| (Cymel ® 203 from Allnex) | |
| 10% dimethylethanolamine in water | 0.2 |
| 2,4,7,9-tetramethy1-5-decynediol, | 0.3 |
| 52% in BG (available from BASF SE) | |
| Rheovis ® AS 1130 available from | 0.2 |
| BASF SE | |
| deionized water | 0.9 |
| Butyl glycol | 3.4 |
| 50 wt % solution of Rheovis ® PU1250 | 0.1 |
| in butyl glycol (Rheovis ® PU1250 | |
| available from BASF SE) | |
| Blue paste (II-2) | 20.4 |
| Aluminum pigment premix: | |
| Mixing varnish MV1 | 3.9 |
| Commercial aluminum pigment, | |
| available from Altana-Eckart | 1.9 |
| (Alu Stapa Hydrolux 2154) | |
| Pigment/binder ratio: | 0.25 |

5 Performance Investigations

5.1 Comparison Between the Noninventive Waterborne Basecoat Materials WBM1 and WBM2 and Also the Inventive Waterborne Basecoat Material WBM3 in Terms of Stability of the Rheological Profile During Storage

The storage stability investigations on the waterborne basecoat materials WBM1 to WBM3 took place in accordance with the method described above. Table 5.1 summarizes the results.

TABLE 5.1
Results of the investigations on viscosity change during storage

| | | Waterborne basecoat material | | |
|---|---|---|---|---|
| | | WBM1 | WBM2 | WBM3 |
| Low-shear | after 5 days’ | 6792.4 | 2827.7 | 5261.6 |
| viscosity | storage at 40° C. | | | |
| (1 s⁻¹) | after 2 weeks’ | 5844.8 | 2716.2 | 5133.0 |
| in mPa · s | storage at 40° C. | | | |
| | Change [%] | −14% | −4% | −2% |
| | after 4 weeks’ | 5764.7 | 2722.9 | 5246.3 |
| | storage at 40° C. | | | |
| | Change [%] | −15% | −4% | 0% |
| | after 8 weeks’ | 5660.3 | 2594.4 | 5328.9 |
| | storage at 40° C. | | | |
| | Change [%] | −17% | −8% | 1% |
| High-shear | after 5 days’ | 94.0 | 111.1 | 101.8 |
| viscosity | storage at 40° C. | | | |
| (1000 s⁻¹) | after 2 weeks’ | 91.8 | 107.8 | 102.3 |
| in mPa · s | storage at 40° C. | | | |
| | Change [%] | −2% | −3% | 0% |
| | after 4 weeks’ | 92.9 | 109.0 | 103.7 |
| | storage at 40° C. | | | |
| | Change [%] | −1% | −2% | 2% |
| | after 8 weeks’ | 92.7 | 109.7 | 105.7 |
| | storage at 40° C. | | | |
| | Change [%] | −1% | −1% | 4% |

Elimination of the synthetic phyllosilicate in combination with the white paste (comparative 1) leads, by comparison with the reference WBM1, fundamentally to a much lower low-shear viscosity, which suggests massive run problems. This shows that a coating material which comprises a microgel dispersion (MD) and is also free of synthetic phyllosilicates may fundamentally be able to be applied without the use of a specific pigment paste (II), but exhibits distinct weaknesses in industrial service in the coating of three-dimensional substrates such as automobile bodies having surfaces to be coated vertically.

In the case of the inventive basecoat material WBM3, in contrast, the microgel dispersion (MD1) in combination with the inventively essential paste (II-2) results in a significantly higher low-shear viscosity level by comparison with WBM2.

Furthermore, significant advantages were found for WBM3 with regard to the stability in the low-shear range.

5.2 Comparison Between the Noninventive Waterborne Basecoat Materials WBM4 and WBM5 and Also the Inventive Waterborne Basecoat Material WBM6 in Relation to Stability of the Rheological Profile During Storage, Shade and Flop Effect, and Film Thickness-Dependent Leveling

The investigations on waterborne basecoat materials WBM4 to WBM6 in respect of storage stability, flop effect, and film thickness-dependent leveling took place in accordance with the methods described above. Tables 5.2 to 5.4 summarize the results.

TABLE 5.2
Results of the investigations on change in viscosity on storage

| | | Waterborne basecoat material | | |
|---|---|---|---|---|
| | | WBM4 | WBM5 | WBM6 |
| Low-shear | fresh | 4796.1 | 1038.2 | 6377.9 |
| viscosity | after 4 weeks’ | 3970.6 | 1193.0 | 5123.5 |
| (1 s⁻¹) | storage at 40° C. | | | |
| in mPa · s | Change [%] | −17.2% | 14.9% | −19.7% |
| High-shear | fresh | 80.1 | 82.6 | 84.7 |
| viscosity | after 4 weeks’ | 70.6 | 76.9 | 89.2 |
| (1000 s⁻¹) | storage at 40° C. | | | |
| in mPa · s | Change [%] | −11.9% | −6.9% | 5.3% |

The storage stability of waterborne basecoat materials WBM4 to WBM6 proved essentially to be comparable. It is found, however, that only in the case of the inventive waterborne basecoat material WBM6 is it possible to compensate the significant loss of low-shear viscosity through elimination of the synthetic phyllosilicates (in this regard, compare WBM5). On the basis of the inventively essential combination of the microgel dispersion (MD1) with the pigment paste (II-2), indeed, an even higher low-shear viscosity level is found for WBM6 than in the case of the reference WBM4.

In total it is found, again, that a coating material comprising a microgel dispersion (MD) with omission of synthetic phyllosilicates, without combination with a paste (II), will have massive problems in relation to runs.

TABLE 5.3
Results of the investigations on shade/flop effect

| | Waterborne basecoat material | | |
|---|---|---|---|
| Flop index | WBM4 | WBM5 | WBM6 |
| fresh sample | 16.2 | 14.1 | 16.8 |
| after 5 weeks’ storage | 16.8 | 14.4 | 17.8 |
| at room temperature | | | |

In spite of the absence of synthetic phyllosilicates, the inventive basecoat material WBM6 gave the best effect pigment orientation. Indeed, a flop effect was found which is above that of the reference containing synthetic phyllosilicates. In WBM5, in contrast, a significantly poorer flop is found.

TABLE 5.4
Results of the investigations on film
thickness-dependent leveling

| Charac- | Film thickness | | | |
|---|---|---|---|---|
| teristic | range (Waterborne | | | |
| value | basecoat material | Waterborne basecoat material | | |
| Appearance | wedge paint system) | WBM4 | WBM5 | WBM6 |
| SW | 10 μm-15 μm | 21.5 | 24.1 | 21.6 |
| | 15 μm-20 μm | 22.6 | 25.8 | 21.6 |
| | 20 μm-25 μm | 24.7 | 27.4 | 25.2 |
| | 25 μm-30 μm | 26.0 | 28.1 | 27.9 |
| | 30 μm-35 μm | 29.7 | 28.7 | 28.6 |
| LW | 10 μm-15 μm | 12.4 | 11.2 | 12.2 |
| | 15 μm-20 μm | 12.5 | 11.1 | 11.8 |
| | 20 μm-25 μm | 14.8 | 9.7 | 13.2 |
| | 25 μm-30 μm | 15.8 | 10.2 | 12.6 |
| | 30 μm-35 μm | 16.1 | 9.8 | 13.1 |

Relative to the reference WBM4, the inventive multicoat paint system based on the waterborne basecoat material WBM6 exhibits slight advantages in terms of short wave (SW) and long wave (LW). For the sample WBM5, better LW values are again found resulting, as interpreted by the skilled person, from the low low-shear viscosity.

5.3 Comparison Between the Noninventive Waterborne Basecoat Materials WBM7 and WBM9 and Also the Inventive Waterborne Basecoat Materials WBM8 and WBM10 in Terms of Stability of the Rheological Profile on Storage, and Shade and Flop Effect

The investigations on waterborne basecoat materials WBM7 to WBM10 with regard to storage stability and also flop effect took place in accordance with the methods described above. Tables 5.5 and 5.6 summarize the results.

TABLE 5.5
Results of the investigations into change in
viscosity on storage

| | | Waterborne basecoat material | | | |
|---|---|---|---|---|---|
| | | WBM7 | WBM8 | WBM9 | WBM10 |
| Low-shear | fresh | 4623.6 | 3280.1 | 2546.5 | 2467.5 |
| viscosity | after 2 weeks’ | 3292.6 | 3078.7 | 1466.7 | 1977.3 |
| (1 s⁻¹) | storage at 40° C. | | | | |
| in mPa · s | Change [%] | −28.8% | −6.1% | −42.4% | −19.9% |
| | after 21 days’ | 3540.0 | 3184.4 | 1672.0 | 2279.4 |
| | stirring test at room | | | | |
| | temperature | | | | |
| | Change [%] | −23.4% | −2.9% | −34.3% | −7.6% |
| High-shear | fresh | 82.0 | 83.1 | 83.9 | 83.7 |
| viscosity | after 2 weeks’ | 74.4 | 84.7 | 64.8 | 76.3 |
| (1000 s⁻¹) | storage at 40° C. | | | | |
| in mPa · s | Change [%] | −9.3% | 1.9% | −22.8% | −8.9% |
| | after 21 days’ | 77.7 | 84.0 | 66.8 | 71.8 |
| | stirring test at room | | | | |
| | temperature | | | | |
| | Change [%] | −5.2% | 1.1% | −20.4% | −14.2% |

The inventive waterborne basecoat materials WBM8 and WBM10 are notable for better storage stability by comparison with the respective references WBM7 and WBM9.

TABLE 5.6
Results of the investigations into shade/flop effect

| | Waterborne basecoat material | | | |
|---|---|---|---|---|
| Flop index | WBM7 | WBM8 | WBM9 | WBM10 |
| fresh sample | 14.2 | 14.5 | 12.8 | 13.5 |
| after 18 days’ storage at 40° C. | n.d. | n.d. | 12.6 | 12.7 |
| after 21 days’ stirring test at | n.d. | n.d. | 12.2 | 13.2 |
| room temperature | | | | |

In relation to the effect pigment orientation as well, advantages are found for the inventive waterborne basecoat materials WBM8 and WBM10.

5.4 Evaluation of the Noninventive Waterborne Basecoat Material WBM11 for Viscosity and Stability of the rheological profile on storage

The storage stability investigations on waterborne basecoat material WBM11 took place in accordance with the method described above. Table 5.7 summarizes the results.

TABLE 5.7
Results of the investigations into change in viscosity on storage

| | | WBM11 |
|---|---|---|
| Low-shear | fresh | 19950.0 |
| viscosity | after 1 week’s storage at 40° C. | 14310.0 |
| (1 s⁻¹) | Change [%] | −28.3% |
| in mPa · s | after 2 weeks’ storage at 40° C. | 11670.0 |
| | Change [%] | −41.5% |
| High-shear | fresh | 85.0 |
| viscosity | after 1 week’s storage at 40° C. | 99.3 |
| (1000 s⁻¹) | Change [%] | 16.8% |
| in mPa · s | after 2 weeks’ storage at 40° C. | 100.1 |
| | Change [%] | 17.8% |

The noninventive waterborne basecoat material WBM11, with a high fraction of synthetic phyllosilicate, has much too high a low-shear viscosity, leading to poor atomization of the material and also to poor leveling.

After just a few days of storage at 40° C., the sample undergoes extreme thickening and resembles a paste/gel. Nevertheless, it can again be measured rheologically; the shearing of the sample in the load phase (see section 4 of the method description “Determination of low-shear and high-shear viscosity”) destroys the gellike structure. After storage, the low-shear viscosity level goes down by more than 40%, but after 2 weeks, at more than 11 500 mPa·s, is still very high. Overall, therefore, WBM11 exhibits an unacceptable stability behavior on storage.

1. An aqueous basecoat material comprising:
(I) a binder comprising at least one aqueous, acrylate-based microgel dispersion (MD), and
(II) at least one pigment paste comprising:
(IIa) at least one color and/or effect pigment, and
(IIb) a paste binder comprising at least one polymer of olefinically unsaturated monomers, where the at least one polymer comprises:
(IIb.1) functional groups for nonionic stabilization of the at least one polymer in water, and
(IIb.2) functional groups selected from the group consisting of silicon-containing, phosphorus-containing, and urea-containing groups,
wherein the aqueous basecoat material comprises less than 0.5 wt %, based on a total weight of the aqueous basecoat material, of synthetic phyllosilicates.

2. The aqueous basecoat material as claimed in claim 1, further comprising at least one inorganic effect pigment.

3. The aqueous basecoat material as claimed in claim 1, further comprising at least one inorganic effect pigment and at least one color pigment, the at least one color pigment being used as pigment (IIa) in a pigment paste (II).

4. The aqueous basecoat material as claimed in claim 1, wherein the functional groups for nonionic stabilization of the at least one polymer in water (IIb.1) are selected from the group consisting of poly(oxyalkylene) groups.

5. The aqueous basecoat material as claimed in claim 1, wherein the functional groups (IIb.2) are selected from the group consisting of:
silicon-containing groups described by the following formula (A): 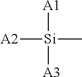
where (A1), (A2) and (A3) are independently selected from hydroxyl groups, alkyl groups having 1 to 10 carbon atoms, alkoxy groups having 1 to 10 carbon atoms, alkoxyalkoxy groups having 2 to 10 carbon atoms, alkanoyloxy groups having 2 to 10 carbon atoms, and halogen groups, with proviso that at least one of the groups (A1), (A2) and (A3) is not an alkyl group,
phosphorus-containing groups described by the following formula (B): 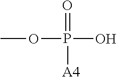
where (A4) is a hydroxyl group, alkyl group having 1 to 10 carbon atoms, alkoxy group having 1 to 10 carbon atoms, alkoxyalkoxy group having 2 to 10 carbon atoms, alkanoyloxy group having 2 to 10 carbon atoms, or a halogen group, and/or
urea-containing groups described by the following formula (C): 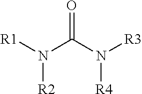
where radicals R1 to R4 are independently selected from hydrogen or organic radicals, it also being possible for the radicals to form ring structures, with proviso that at least one of the radicals R1 to R4 is divalent and links a urea function to the at least one polymer.

6. The aqueous basecoat material as claimed in claim 5, wherein the functional groups (IIb.2) are selected from the group
of phosphorus-containing groups described by the following formula (B): 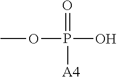
where (A4) is a hydroxyl group, alkyl group having 1 to 10 carbon atoms, alkoxy group having 1 to 10 carbon atoms, alkoxyalkoxy group having 2 to 10 carbon atoms, alkanoyloxy group having 2 to 10 carbon atoms, or a halogen group.

7. The aqueous basecoat material as claimed in claim 5, wherein the functional groups (IIb.2) are selected from the group consisting
of urea-containing groups described by the following formula (C): 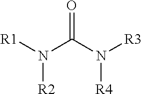
where radicals R1 to R4, are independently selected from hydrogen or organic radicals, it also being possible for the radicals to form ring structures, with proviso that at least one of the radicals R1 to R4 is divalent and links a urea function to the at least one polymer.

8. The aqueous basecoat material as claimed in claim 1, comprising less than 0.15 wt % of synthetic phyllosilicates.

9. The aqueous basecoat material as claimed in claim 1, wherein a polymer present in the acrylate-based microgel dispersion (MD) has an average particle size of 100 to 500 nm.

10. The aqueous basecoat material as claimed in claim 1, wherein the acrylate-based microgel dispersion (MD) is prepared by means of radical emulsion polymerization.

11. The aqueous basecoat material as claimed in claim 10, wherein the acrylate-based microgel dispersion (MD) comprises successive radical emulsion polymerization of three different mixtures, (A), (B), and (C), of olefinically unsaturated monomers,
where
a polymer prepared from the mixture (A) possesses a glass transition temperature of 10 to 65° C.,
a polymer prepared from the mixture (B) possesses a glass transition temperature of −35 to 15° C., and
a polymer prepared from the mixture (C) possesses a glass transition temperature of −50 to 15° C.

12. A method for producing a multicoat paint system, the method comprising:
(1) producing a basecoat film on a substrate or producing a plurality of directly successive basecoat films on a substrate by applying an aqueous basecoat material or directly successively applying two or more aqueous basecoat materials to the substrate,
(2) producing a clearcoat film on the basecoat film or an uppermost basecoat film,
(3) jointly curing the basecoat film and the clearcoat film or the basecoat films and the clearcoat film,
wherein the aqueous basecoat material in stage (1) or at least one of the two or more aqueous basecoat materials used in stage (1) is an aqueous basecoat material as claimed in claim 1.

13. The method as claimed in claim 12, wherein said substrate is a metallic substrate coated with a cured electrocoat system and all layers applied thereto are jointly cured.

14. The method as claimed in claim 12, wherein the basecoat material is applied exclusively via electrostatic spray application.

15. A multicoat paint system producible by a method as claimed in claim 12.

16. The aqueous basecoat material as claimed in claim 4, wherein the functional groups for nonionic stabilization of the polymer in water (IIb.1) are poly(oxyethylene) groups.

17. The aqueous basecoat material as claimed in claim 8, wherein the aqueous basecoat material is entirely free of synthetic phyllosilicates.
